(19) United States
(12) Patent Application Publication
(10) Pub. No.: US 2014/0122143 A1
(43) Pub. Date: May 1, 2014

(54) OPTIMIZING RESOURCE ASSIGNMENT

(71) Applicant: TRIMBLE NAVIGATION LIMITED, Sunnyvale, CA (US)

(72) Inventors: Brian Fletcher, Felixstowe (GB); Robert Noel William Laithwaite, Ipswich (GB); Evgeny Selensky, Ipswich (GB); Paul Sexton, Leicester (GB)

(73) Assignee: TRIMBLE NAVIGATION LIMITED, Sunnyvale, CA (US)

(21) Appl. No.: 13/664,338

(22) Filed: Oct. 30, 2012

(51) Int. Cl. G06Q 10/06

(52) U.S. Cl. CPC G06Q 10/063112
USPC 705/7.14

(57) ABSTRACT

A system is described that has a first engine configured to determine an assignment of a resource to a task. The assignment is based on a schedule representation comprising at least resource profile data and task profile data. The resource profile data represents a resource profile associated with the resource and the task profile data represents a task profile associated with the task. The system also has a data store configured to store a set of rules, the set of rules comprising data indicative of one or more functions to be applied to one or more input data sources to output at least one variable value for the schedule representation. This then allows a second engine coupled to the data store to be configured to update the schedule representation in accordance with the set of rules.

### BACKGROUND

An asset management system typically comprises a computerized system for managing assets. These assets may comprise components of an infrastructure, such as a computer, telecommunications, or transport infrastructure. Management of assets may comprise installing, maintaining, repairing, and testing equipment that forms part of said infrastructures. Modern infrastructures are typically too complex to be managed manually; for example, a telecommunications infrastructure may comprise thousands of geographically distributed devices that are owned and maintained by a plurality of parties. An asset management system may thus be vital to the health and efficiency of an infrastructure. Asset management systems may also be used to manage assets within an organization or commercial entity.

Assets may comprise any resource controlled and/or owned by an entity. For example, they may comprise ‘fixed assets’ such as property, plant and equipment, and ‘human resources’ such as technicians, employees, and contractors. Assets may also be dynamic, i.e. they may change state over time. They may break-down, need to be maintained or repaired, or be replaced or installed. An asset management system may manage both sets of resources with one electronic system, for example monitor and/or respond to job requests relating to fixed assets and appropriately assign human resources and/or equipment.

Asset management systems have evolved from systems that are configured and managed manually to ones that are predominantly automated. In the case of manual systems, in the event that an electronic device forming part of a telecommunications network stopped functioning, this would have led to interruption of service for one or more telecommunications customers. These customers would have been required to notify the telecommunications provider who then in turn would identify and send a technician to investigate the status of the electronic device. In this case, “investigate status of electronic device X” may have been a task to assign to a particular technician employed by the telecommunications provider. In a small organisation located locally to the malfunctioning device with only one technician, availability of the technician would have needed to be considered. This could take the form of checking a paper diary. An assignment may then be made manually by writing into the paper diary at a free space a time to perform the task. However, this arrangement is not scalable in relation to modern organisations. Firstly, an organisation may need to maintain a high availability of a service. In telecommunications this may be so-called ‘five nines’ availability (i.e. a downtime of less than 5.26 minutes per year). In an emergency vehicle dispatch service, there may be a maximum response time to an incident, which in some cases may be set by statute. In these cases, a resource must be scheduled to fulfil a task within a set of stringent time constraints. Secondly, an organisation may have widely distributed resources; it may not be possible or efficient for a human resource to physically reach a geographical location where a task needs to be performed. Thirdly, an organisation may need to manage a large number of resources that may change state unpredictably, yet they may also be under a budget constraint or need to make a profit; hence, it may not be affordable to maintain too many human resources, but too few resources may not be able to meet availability and/or safety requirements for a service.

In response to the requirements discussed above, asset management systems comprising one or more electronic devices that support human operators have been proposed.

As described in US 2003/0041087 A1, tasks such as repair jobs in a telecommunications system, which are to be performed by a plurality of resources such as field engineers at different locations in a geographical area, are scheduled by means of a scheduler at a work manager server. The scheduler provides schedule data corresponding to schedules of the tasks that individual ones of the resources are to carry out, from task data concerning the tasks to be carried out and resource data concerning characteristics of resources available to carry out the tasks over a given period. In general, not all the tasks may be scheduled, resulting in unscheduled task data. For example, a scheduling process may be performed as a batch process, i.e. take place at a predetermined time, and new tasks may be received after this predetermined time. These new tasks are labelled “unscheduled task data”. The schedule data is downloaded to a workstation together with the unscheduled task data. The downloaded data is analysed at the workstation to determine a candidate resource to perform the task corresponding to the unscheduled task data.

U.S. Pat. No. 7,464,046 B2 describes a service support system that includes a service request interface, a dispatch system interface, and a service assignment module. The service request interface is configured to communicate with a service request system. The dispatch system interface is configured to communicate with a dispatch system. The service assignment module is configured to assign a particular service request to a particular technician based at least in part on a historical technician performance statistic. The particular service request is received via the service request interface. The service assignment module notifies the particular technician of the service request via the dispatch system interface.

US 2009/0199192 A1 describes examples that are concerned with allocating resources to tasks and have particular application to situations where the availability of resources and the tasks to be performed change dynamically and the resources are mobile. Examples utilise a selection criterion that enables actual location data to be used for the scheduling of future work: this selection criterion is associated with the status of the resource in relation to progress with a given task, and can most appropriately be identified on the basis of whether or not the resource has completed a task.

Systems such as those described above help somewhat to assign resources such as field engineers or technicians to a task or service request. However, they leave room for improvement in the efficient allocation of resources to tasks. For example, many resources in modern organisations are “on the move” during a working day, i.e. they have a variable location and often do not return to a central site. Resources may also use a variety of vehicles and visit a number of different sites, some of which may be static while others may change. Modern equipment is increasingly complex, requiring an ever increasing set of skills from a resource to fulfil a task. Exceptions to a set of schedules may also occur, i.e. actual circumstances may not match a prepared schedule, and new tasks may be received throughout an operational period such as a working day. This makes it difficult to assign a resource to a task in an efficient manner, for example, without leading to wasted time, inactive equipment or safety risks. It is also useful for an asset management system to cope with at least one or more of uncertainty (in various forms), data unavailability and data inaccuracy. Different organizations also have different cultures and operational styles. It is difficult for computerized systems to accommodate these and typically an organization is required to adapt their procedures for an asset management system.

It is also difficult to set-up an automated or semi-automated assignment system when faced with dynamic workload and resourcing situations and uncertainty. Uncertainty may be defined with regard to at least data values, e.g. stored data may not accurately reflect current circumstances, and events, e.g. it may be difficult or impossible to predict events such as the arrival of new tasks, unforeseen errors and resource unavailability (e.g. due to illness).

### SUMMARY

According to a first embodiment, there is provided a system comprising a first engine configured to determine an assignment of a resource to a task, the assignment being based on a schedule representation comprising at least resource profile data and task profile data, the resource profile data representing a resource profile associated with the resource and the task profile data representing a task profile associated with the task, a data store configured to store a set of rules, the set of rules comprising data indicative of one or more functions to be applied to one or more input data sources to output at least one variable value for the schedule representation and a second engine coupled to the data store and configured to update the schedule representation in accordance with the set of rules.

According to a second embodiment, there is provided a method of updating resource data, the method comprising accessing a set of rules from a data store, the set of rules comprising data indicative of one or more functions to be applied to one or more input data sources to output at least one variable value for a schedule representation comprising at least resource profile data representing a resource profile associated with a resource and task profile data, the task profile data representing a task profile associated with the task, processing the one or more input data sources to update the schedule representation in accordance with the set of rules and determining an assignment of the resource to a task, the assignment being based on the schedule representation.

The second embodiment may be implemented using a computer program product comprising a non-transitory computer-readable storage medium having computer-readable instructions stored thereon, the computer readable instructions being executable by a computerized device to cause the computerized device to perform a method according to the second aspect.

Further features and advantages of the examples will become apparent from the following description of preferred embodiments, given by way of example only, which is made with reference to the accompanying drawings.

### BRIEF DESCRIPTION OF THE DRAWINGS

FIG. 1 is a schematic diagram showing a system for optimizing the assignment of resources to tasks according to an example;

FIG. 2 is a schematic diagram showing a system for use in scheduling tasks according to an example;

FIG. 3 is a schematic diagram showing a variation of the system shown in FIG. 2;

FIG. 4 is a schematic diagram showing additional components for use with a second engine according to an example;

FIG. 5 is a flow diagram showing a method of updating resource profile data according to an example;

FIG. 6A is a flow diagram showing a method of updating data indicative of a preferred working area according to an example;

FIG. 6B is a flow diagram showing a method of processing assignment data according to an example;

FIG. 7A is a schematic map showing preferred work areas for a technician following two days of assigned tasks;

FIG. 7B shows a plurality of schematic maps demonstrating a change in the preferred work areas for a technician over a time period;

FIG. 7C is a schematic map showing preferred work areas for a technician following ten days of assigned tasks;

FIG. 8 is a flow diagram showing a method for updating one or more variables of a resource profile according to an example;

FIG. 9A is a schematic diagram illustrating at least a portion of a task skill model according to an example;

FIG. 9B is a schematic diagram illustrating further portions of the task skill model of FIG. 9A together with illustrated links between different model portions;

FIG. 10A is a chart showing a change in an installation skill level for a technician according to an example;

FIG. 10B is a chart showing a change in a maintenance skill level for a technician according to an example;

FIG. 10C is a chart showing a change in a repair skill level for a technician according to an example;

FIG. 10D is a chart showing a change in a test skill level for a technician according to an example;

FIG. 11 is a chart showing a change in a preference of a resource according to an example;

FIG. 12 is a chart showing a change in preferences for two comparative resources according to an example;

FIG. 13 is a flow diagram showing a method of assigning a resource to an unprocessed task according to an example;

FIG. 14 is a flow diagram showing a method of assigning a resource based on safety considerations;

FIG. 15A is a table showing an exemplary set of conditions and conclusions that may comprise a set of learning rules for a driver safety variable;

FIG. 15B is a table showing an exemplary set of conditions and conclusions that may comprise a set of learning rules for a geographic area safety variable;

FIG. 16 is an illustrative screen shot of a map split into regions with different safety levels;

FIG. 17 is a schematic diagram illustrating a number of data sources according to an example; and

FIG. 18 is a block diagram of an example computer system with which, or upon which, various embodiments described herein may be implemented.

### DESCRIPTION OF EMBODIMENTS

Certain examples described herein provide an efficient and convenient learning methodology for use with systems that present an assignment of a resource to a task. These systems may be automated scheduling and/or optimization systems or systems that provide automated advice to human experts. Improved decision making is achieved through an automated method and system for processing assignments, either as they are made or from referring to historic data sources. Improved resource profiles, updated in response to changes over time, lead to higher quality assignments and schedules. In certain examples, higher quality assignments result in higher levels of customer satisfaction, better resource utilization, higher levels of driver safety and schedule stability (e.g. fewer schedule exceptions) and higher workforce preference satisfaction, i.e. human resources are assigned tasks they prefer to complete leading to a happier workforce. Certain examples thus provide for successful scheduling under conditions of uncertainty. They also facilitate the assignment of a resource to a task in the presence of incomplete and/or incorrect data and enable the capture and use of digital information that is difficult to formalise.

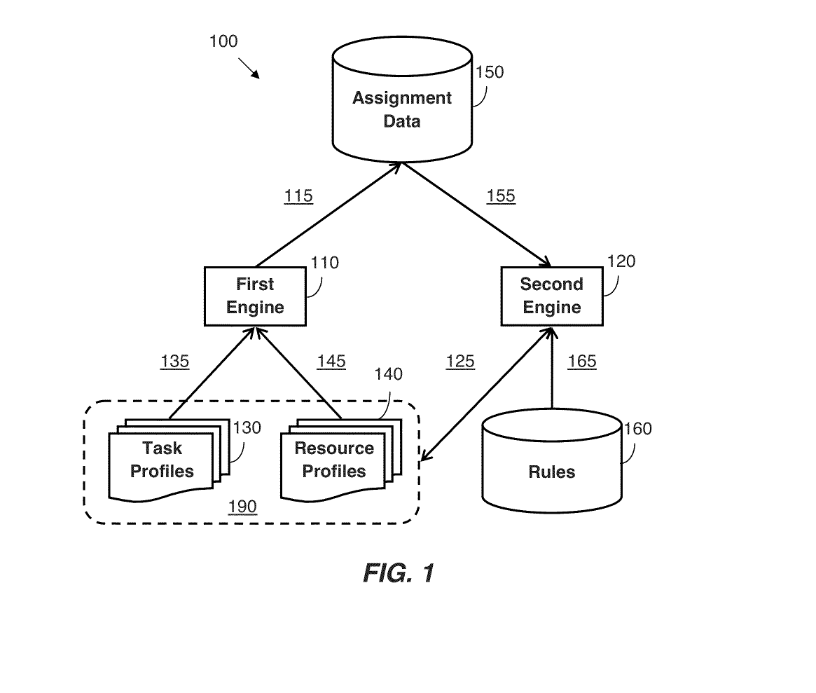

FIG. 1 shows a number of components of a system 100, which may be used in optimizing an assignment of a resource to a task. The system 100 of FIG. 1 comprises a first engine 110 and a second engine 120. The term ‘engine’ is used herein to denote a processing component and as such may be implemented in a number of ways including, amongst others, the processing of computer program code from memory, configurable logic (e.g. Field Programmable Gate Arrays—FPGAs) and/or suitably designed digital electronics (e.g. dedicated circuits and/or monolithic devices). The first engine 110 is arranged and constructed to access data indicative of one or more task profiles 130 and data indicative of one or more resource profiles 140. For ease of explanation the terms ‘resource profile’ and ‘task profile’ will be used respectively as a shortened form of data indicative of a resource profile and data indicative of a task profile; as such these terms may refer to, amongst others, distinct files, memory locations, registers, tables and/or database records.

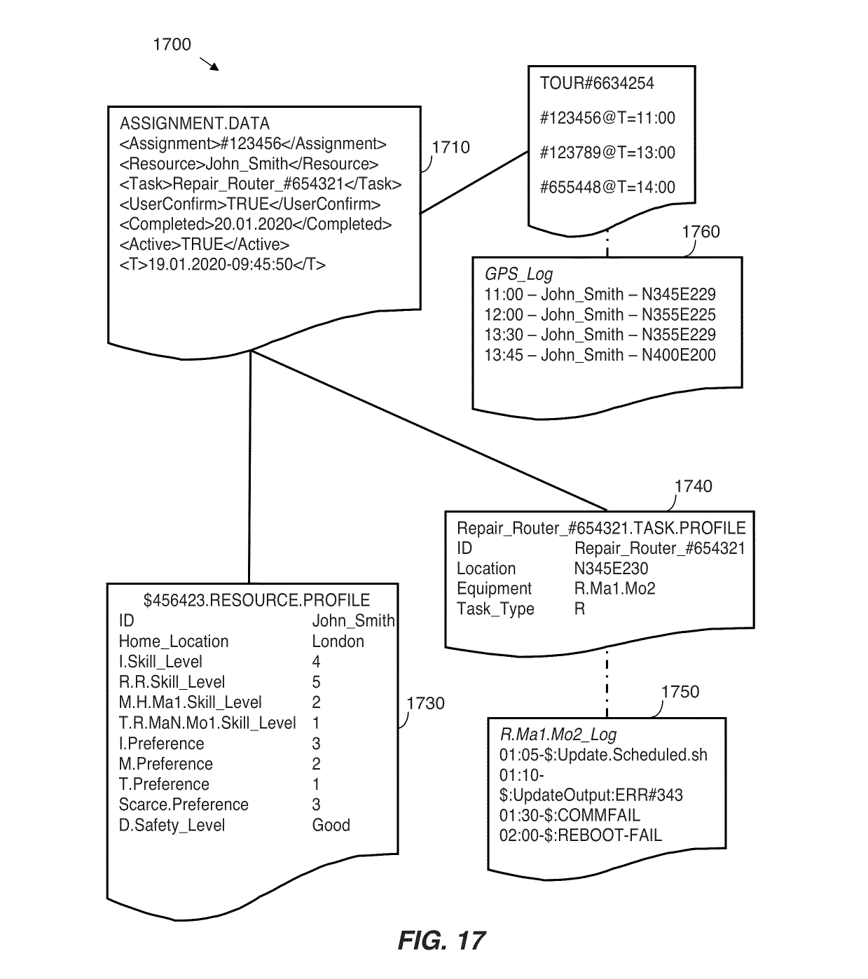

In one example, the first engine 110 is arranged and constructed to retrieve a task profile associated with a task to be assigned via communicative link 135. A communicative link as used herein is representative of a data access mechanism that may comprise the sending and/or receiving of data, or the accessing of data from storage, registers, memory or a file, using any suitable protocol. For example, the first engine 110 may process a list of unassigned tasks, wherein each entry in the list defines a task that has an associated task profile 130. A task profile 130 sets out data indicative of particular task properties and characteristics. These are described in more detail with relation to an example shown in FIG. 17 but may comprise one or more of: a task type, e.g. in a telecommunications implementation this may be one of, amongst others, ‘install’, ‘maintain’, ‘repair’ or ‘test’; a geographical location of a task, e.g. define using a co-ordinate system; an asset or resource associated with the task, e.g. an identifier for a piece of equipment that requires the task to be performed on it; a time or period of time in which the task must be performed; and a priority. A task profile 130 may define particular task properties and characteristics in a single flat file or may contain links or pointers such as primary keys to other files or records containing the information.

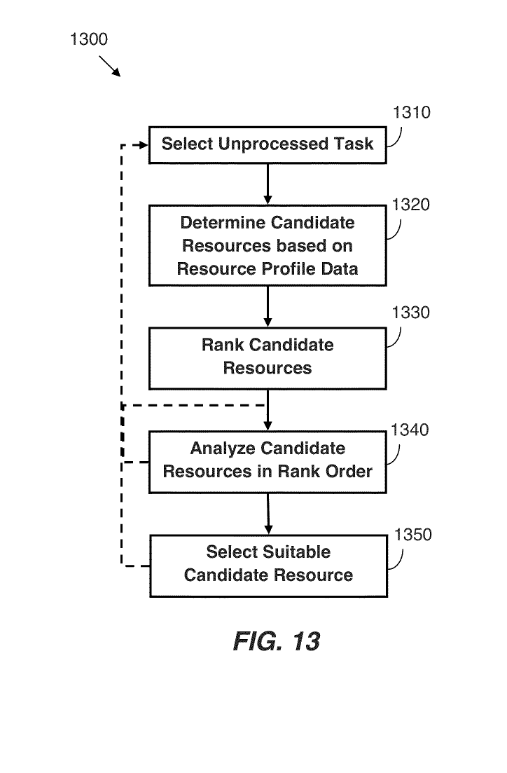

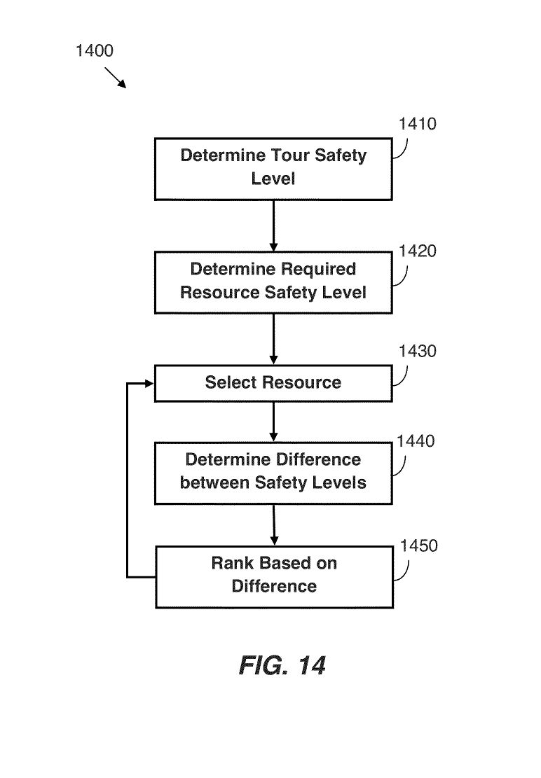

In the example, the first engine 110 is arranged to heuristically determine a resource to assign to a selected task. FIGS. 13 and 14, described later herein, give examples of how this may be implemented. In general, task properties and characteristics defined via a task profile are matched to resource properties and characteristics defined via a resource profile. The first engine 110 accesses one or more resource profiles 140 via communicative link 145. For example, a task profile may indicate a particular item of equipment needs to be installed; the first engine 110 may then search through a plurality of resource profiles in order to identify available resources for a time slot that have a skill variable associated with the item of equipment. If multiple resources can be matched to a task profile, each candidate resource may be ranked based on a weighting or score indicative of the suitability of the match. The first engine 110 may be arranged to access one or more heuristic rules e.g. search strategies (not shown) defined in a logic language. These heuristic rules may be configurable and/or pluggable.

The first engine 110 is arranged to output data indicative of an assignment 115 of a resource to a selected task. Again, for ease of explanation ‘assignment’ will be used as a shortened form of ‘data indicative of an assignment’. The resource may be a candidate resource whose resource profile 140 best matches a task profile 130 defining the task, e.g. a resource with a highest score from a plurality of candidate resources. Depending on the implementation, the assignment 115 output by the first engine 110 may comprise a fixed assignment that is used to create a tour of tasks for a resource to perform on a particular day, or it may comprise a suggested or optimized assignment for comparative use. A suggested or optimized assignment may be confirmed by a user to become a fixed assignment for a tour of tasks. In any case, in FIG. 1, the assignment 115 output by the first engine 110 is subsequently stored in an assignment data store 150. For example, assignment 115 may be represented by a data file or record and the file or record may be stored in a magnetic or solid-state data storage medium. In a simple case, an assignment 115 may comprise a link file comprising identifiers for a task profile and a resource profile. Over time, as the first engine 110 selects other tasks to assign, a plurality of assignments 115 are stored in assignment data store 150, representing a body of historic data.

Even though the examples described herein are from the viewpoint of a one-to-one assignment of a resource to a task, other combinations are possible such as a many-to-one assignment of multiple resources to a task. In the latter cases, when a request to the first engine 110 involves an assignment of more than one resource to a task, the system 100 may be arranged to generate multiple task instances, so that a one-to-one assignment may be maintained. In this case, tasks that require execution in parallel at the same location (assist tasks') or in parallel at different locations (co-op tasks') may be represented by the existence of a corresponding temporal constraint between the start times of those tasks.

The second engine 120 of FIG. 1 is arranged and constructed to update a schedule representation 190 that comprises at least one of a set of one or more resource profiles 140 and a set of one or more task profiles 130, i.e. the data embodying the profiles, over time based on changing data within the system 100. The second engine 120 is arranged to ‘learn’ from data accessible from system 100, i.e. to change data indicative of a schedule representation as more information, such as information associated with the resource, is collected. For example, one or more resource profiles and/or one or more task profiles may be updated. The learning is rule-based, i.e. a schedule representation 190 is updated in accordance with a set of rules. As shown in FIG. 1, a rule data store 160 is supplied that stores one or more rules for updating a schedule representation 190. The one or more rules may be pluggable, i.e. may be replaced and/or supplemented with new rules, and/or configurable by a user. The rules are accessed by the second engine 120 via communicative link 165 during an update procedure. For example, one or more rules may comprise data indicative of one or more functions to be applied to one or more input data sources to output at least one variable value for the schedule representation. These input data sources may include assignment data store 150 as well as other data sources accessible from the system 100: the second engine 120 is arranged to access at least assignment data store 150 via communicative link 155 and to process said assignment data stored in the assignment data store 150 in accordance with one or more rules accessed from the rule data store 160 to update the schedule representation 190, as indicated by arrow 125.

The system 100 may form a closed system. In this case, the second engine 120 repeatedly accesses new assignment data and updates a schedule representation that is in turn used in the assignment of a resource to a task by first engine 110. As the first engine 110 then outputs new assignment data 115 that is stored in assignment data store 150, the system can operate cyclically over time.

Use of system 100, amongst other examples described herein, addresses certain problems that arise from an inherent complexity of scheduling tasks in a modern organisation. Use of the second engine 120 enables data describing and defining resources and/or tasks within the organisation to be updated to meet the needs of a particular environment and/or implementation. It also enables the system 100 to manage change. Use of the second engine 120 may be considered an automatic optimization or ‘tuning’ of the system 100 to requirements, as, for example, updated resource profiles allow for an optimized assignment of a resource to a task to be scheduled.

In certain situations, operational characteristics of an organisation or infrastructure such as, amongst others, quality of service, resource consumption and workforce preferences, may vary considerably for different organisations or implementations and may also be sensitive to a locale and time or date, e.g. a time of day or a day of a week. If system 100 is used in addition to an existing scheduling system, for example if first engine 110 is arranged to provide assignment data 115 representing an optimized assignment for comparison and/or confirmation, then acceptance of one or more optimized assignments may also result in increased efficiencies. By optimizing or ‘tuning’ a scheduling system, organisations can achieve considerable savings, for example in terms of workforce time, fuel consumption and/or monetary cost and/or environmental impact. Examples, such as that shown in FIG. 1, automate the process of performance tuning and as such, make it easier for new users to introduce and gain benefits from automated scheduling systems. As the second engine 120 updates schedule representation automatically as the system 100 operates, many man-hours of data entry, scheduling experts and/or computer personnel may be saved. For example, by updating one or more resource profiles 140 based on assignment data, relevant data for optimization may be retrieved without human intervention. The time required for data setup and/or maintenance may also be reduced and the system 100 may be more robust, e.g. less likely to generate errors or exceptions. Exceptions themselves can also be learned; for example, the variable configurations that result in an exception can be learned such that exceptions may be avoided in a scheduling process.

The second engine 120 may also be configured to learn based on assignment histories of variable duration. Learning different aspects of the scheduling process can be done via rules using existing or novel machine learning techniques. For example, actual task durations of successfully completed tasks may be used by the second engine 120 to generate estimated task durations (e.g. a learning rule may be to average a particular set of task durations). These estimated task durations may then be automatically added to a task profile. This has many advantages, for example, it adapts automatically to change. E.g. if the average execution time of a particular type of task decreases, the second engine 120 can automatically update the profile of this type of task. The second engine 120 may also use assignment data such as customer satisfaction, for example as provided by electronic feedback forms from customer terminals. In this case a relationship between one or more variable values in the schedule representation 190 and a customer satisfaction score may be learnt such that the first engine 110 provides assignments that are predicted to have a high customer satisfaction score. Recordal and use of a customer satisfaction score also allows an independent assessment of learning efficiency. Similar learning rules may also allow ranking resources by customers based on personal preference. Typically, a company using a system according to an embodiment have customers, and it is these customers that provide feedback on the user's workforce performance. Such customer feedback can be used to independently assess quality and stability of learning.

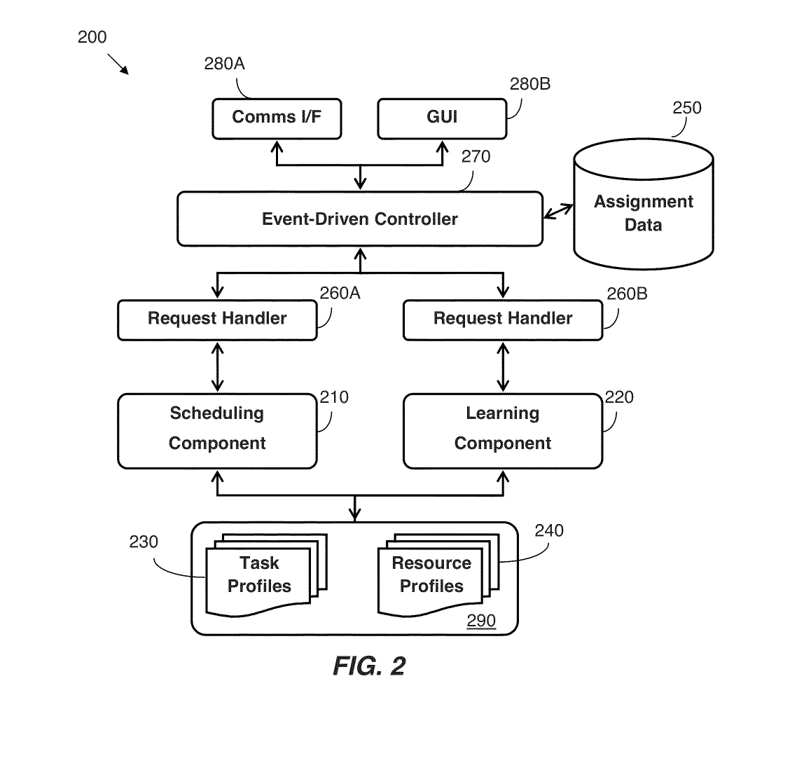

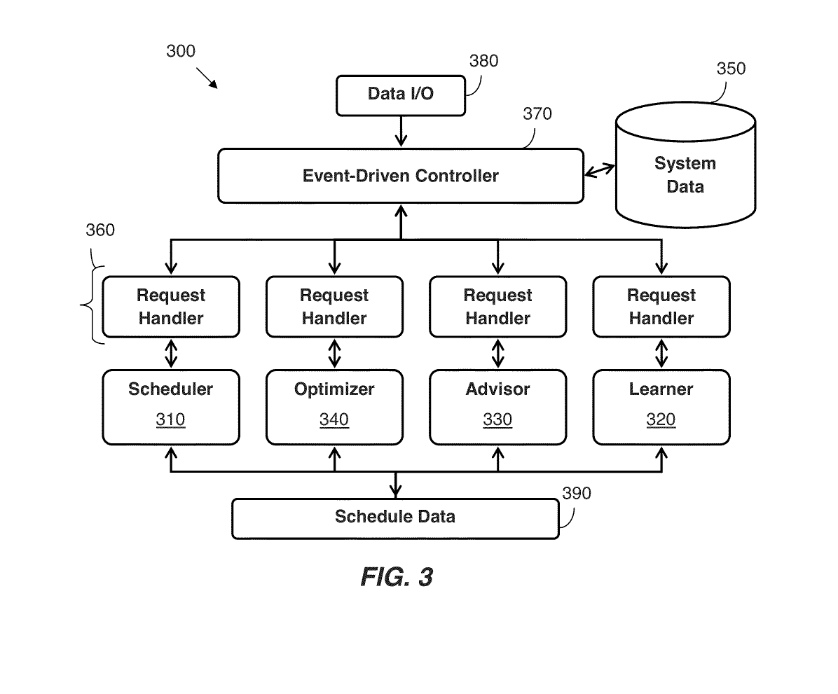

FIG. 2 shows another example system 200 that applies certain concepts described above with regard to FIG. 1. Certain relationships with features of FIG. 1 are denoted by common reference numeral suffixes, e.g. scheduling component 210 may implement functions of first engine 110. In FIG. 2, a scheduling component 210 and/or a learning component 220 access one or more of task profiles 230 and resource profiles 240. The task profiles 230 and the resource profiles 240 collectively form part of a schedule representation 290, i.e. may comprise data structured and formatted according to a particular framework or schema for use in generating a schedule and/or assigning a task. The schedule representation 290 may also comprise system parameters to configure the global behaviour of the system 200. A data handler (not shown) may be provided to allow modification of data forming the schedule representation 290, e.g. to modify the details of a task as set out in a task profile 230 or details of a resource set out in a resource profile 240. The modification scheduling component 210 may comprise one or more of a scheduler, an optimizer and an advisor. These components are described in more detail with regard to FIG. 3.

In a similar manner to first engine 110, scheduling component 210 is arranged to retrieve an unscheduled task and assign one or more resources to that task to generate assignment data. The assignment data may be an assignment to be used to generate a schedule for a resource, e.g. a daily schedule for a technician or other member of staff, or may be a suggested or optimised assignment for comparison with a manual assignment and/or confirmation. In the latter case, the scheduling component 210 may be arranged to receive data representative of a manual assignment and operate to determine if a more efficient assignment can be made according to one or more metrics. In any case, the scheduling component 210 matches characteristics of a task set out or referenced in a task profile 230 with characteristics of a resource set out or referenced in a resource profile 240. As such it accesses the data of the schedule representation 290 via a communicative link. A resource may be, amongst others, a human resource such as a technician or driver, a piece of equipment or a vehicle.

In a similar manner to second engine 120, learning component 220 is arranged to update data used by system 200 to assign a resource to a task in response to changes in data recorded as tasks are scheduled and completed. In one case, learning component 220 updates schedule representation 290, e.g. one or more task profiles 230 and/or one or more resource profiles 240, based on data associated with one or more assignments. In another case, data generated by learning component 220 is used to inform one or more heuristic rules (not shown) used by the scheduling component 210. Learning component 220 may be arranged to operate in an offline mode, e.g. by processing historic data in batches, and/or in an online mode, e.g. by monitoring data generated by system 200 such as user decisions in real-time. Like second engine 120, learning component 220 may use a set of learning rules to determine how to configure schedule representation 290. The set of learning rules may be pluggable and/or configurable. The set of learning rules define how to update the schedule representation 290 based on acquired data. For example, they may define how to update one or more of variables representative of a geographical preference for a resource, variables representative of a resource safety record and/or an area safety record (e.g. relating to transport), and variables representative of specialization for a resource (e.g. relating to a task or work type or an equipment characteristic). Data generated by the learning component 220 may be used in the construction of a schedule of tasks or in an optimization procedure via the action of scheduling component 210 and its use of one or more of the heuristic rules and schedule representation 290. Data generated by the learning component 220 may also be made available to the user in the form of advice about the implications of user choices. The learning component 220 may modify the schedule representation 290 directly, e.g. by writing to a data file representing the profile, or may make use of an interface (e.g. an application programming. interface (API)) provider by a data handler as described above.

FIG. 2 further shows a number of components that may be used to interface at least one of the scheduling component 210 and the learning component 220 with either a user or other system components, including an event-driven controller 270. The event-driven controller 270 is arranged and constructed to manage events that occur within the system 200. An event is an action generated by a portion of computer program code or hardware device; for example, an event may be generated by the receipt of a signal or message (referred to for simplicity as a ‘signal’) at one or more processors from an electronic device or computer program code that is being processed by a processor. A signal may indicate an interrupt, or a change in computer hardware, such as the setting of a variable or flag in memory. The event-driven controller 270 may comprise a control interface that receives signals from at least one of a communications interface 280A and a graphical user interface (GUI) 280B, as well as internal components, such as one or more request handlers 260. The communications interface 280A may enable the event-driven controller 270 to communicate with one or more networked services and systems, such as web services or remote data sources. On receipt of a signal indicating an event the event-driven controller 270 is configured to respond appropriately. For example, the event-driven controller 270 may comprise conditional logic that defines a further action to be taken on receipt of a signal. This action may be to send a signal to one of a first request handler 260A and a second request handler 260B. The first request handler 260A may then communicate with the scheduling component 210 and the second request handler 260B may then communicate with the learning component 220. The scheduling component 210 and/or the learning component 220 may then respond to an event in an appropriate manner. This may involve generating further events, causing a chain of actions to take place. The event-driven controller 270 may be arranged to send signals to one or more of the request handlers 260 to invoke one or more of the scheduling component 210 and the learning component 220 based on a priority scheme.

One or more of the scheduling component 210 and the learning component 220 may need to be registered with the event-driven controller 270, either directly or via an appropriate request handler 260. Registration may comprise registering as an observer of a specific change event generated or indicated by the event-driven controller 270. For example, the event-driven controller 270 may maintain an internal state that is accessible by a component; a component may then register to be notified whenever a change occurs in the internal state, which may occur due to the receipt of an event notification and management of events from components such as the communications interface 280A and the GUI 280B.

A control interface of the event-driven controller 270 may act as a server, accepting one or more requests from registered clients, for example a user workstation comprising GUI 280B or a networked device via communications interface 280A. For example, a client may request that a task is to be scheduled. In this case, the event-driven controller 270 receives the request as an event notification and subsequently changes its visible state to indicate that a task needs to be assigned. For example, conditional logic of the event-driven controller 270 may define a process for splitting a request for a schedule into a number of tasks to be assigned. These may be tasks to be assigned to a resource located at a particular geographical location, where the particular geographical location forms part of the constraints embodied by the task profile 230. The first request handler 260A then is notified via a communicative link of the change in state, or alternatively polls the event-driven controller 270, and handles a subsequent request to assign a task. The first request handler 260A invokes the scheduling component 210 to assign the task based on the schedule representation 290. Assignment data generated by the scheduling component 210, which represents an assignment of the task to a resource, is then communicated back to, or detected by, the first request handler 260A. The first request handler 260A in turn updates the state of the event-driven controller 270, either directly or through the generation of an event. The event-driven controller 270 monitors its state to determine whether all sub-processes required to fulfill a client request have been completed. When all sub-processes are complete, data generated by the components is packaged by the event-driven controller 270 and sent to the appropriate client to complete the request. In certain examples, the control interface of the event-driven controller 270 may be the only component that is able to update a state of the event-driven controller 270. A client request or sub-process may specify and/or reference additional parameters for processing the request or sub-process. For example, amongst others, a client request or sub-process may indicate a required time window for execution and/or a relationship with a particular tour or set of tours.

In one example, the event-driven controller 270 may be arranged to receive request in the form of a function call for a single function, e.g. PERFORM(arg_operation, arg_{—}1, . . . arg_n), where ‘arg_operation’ indicates the name of an operation that the system 200 is to perform and ‘arg_{—}1, . . . arg_n’ indicate one or more arguments (if required). In certain cases, a control interface for handling PERFORM requests may be implemented externally to the event-driven controller 270, such that system 200 has a single interface for receiving service requests from client devices. A mechanism configured in this manner allows for new functionality to be added, for example by adding operations, without requiring changes to an interface of the system 200. Functionality may also be added by supplying replacement or additional libraries representative of new or updated request handlers 260.

Request handlers 260A, 260B (alternatively referred to hereinafter as 260) such as those shown in FIG. 2 may represent knowledge sources that respond to client requests, the knowledge sources being embodied by the functionality of components such as the scheduling component 210 and the learning component 220. In certain cases, a request handler 260 for a particular component, rather than the event-driven controller 270 may perform preliminary (i.e. pre-) processing of a request from a client. For example, a request may comprise a work package, e.g. a group of related tasks to be performed, possibly in a particular order. In this case, a request handler 260 for a pre-processing component (not shown in FIG. 2) is notified of the receipt of a work package, e.g. by a change in the state of the event-driven controller 270, and, together with the pre-processing component, extracts constituent tasks that are not assigned and creates an event, e.g. for each task, to be handled by the event-driven controller 270 to invoke the operation of the first request handler 260A and the scheduling component 210. The same pre-processing component, or a further post-processing component and additional request handler, may then be responsible for packaging the individually assigned tasks as a processed work package for return to a client. In certain instances, the functionality of a processing component may be implemented together with the functionality of a request handler, for example as a single process or thread in a computing system. Such a process or thread may be responsible for configuring one or more parameters for one of the other components, e.g. scheduling component 210 or learning component 220.

During the operations described above, the event-driven controller 270, or a dedicated component coupled to the event-driven controller 270, is arranged to store the results of client requests in assignment data store 250. This may take the form of a data dump of selected states of the event-driven controller 270 or listener components arranged to echo or copy the results of requests and sub-processes that pass through the event-driven controller 270 during an operation. For example, if the event-driven controller 270 is associated with a single internal or external control interface, data that crosses that interface may be stored, such as assignments of resources to tasks, as well as user events received via GUI 280B and data received from communications interface 280A. The structure of the assignment data store 250 may depend on the implementation.

FIG. 3 shows a third example that is an extension of the system 200 shown in FIG. 2. As in FIG. 2, system 300 comprises a number of request handlers 360 that communicate with an event-driven controller 370, which is in turn communicatively coupled to one or more data interfaces (i.e. for input/output or I/O) 380, which may allow coupling to one or more data sources. Each request handler 360 handles requests as described above for one of four processing components: a scheduler 310, an optimiser 340, an advisor 330 and a learner 320. The scheduler 310, optimizer 340, and advisor 330 provide functionality associated with scheduling component 210 and first engine 110, while the learner 320 provides functionality associated with learning component 220 and second engine 120. Each of the processing components may access a schedule representation 390, which may comprise one or more task profiles 230 and one or more resource profiles in a similar manner to schedule representation 290. The schedule representation 390 may also comprise data that is used during the construction and/or revision of a schedule of assigned tasks, for example possible matches and/or lists of candidate resources. The schedule representation 390 may comprise error handling components to monitor for errors and ensure data integrity and/or constraint propagation components for use in generating a schedule that matches one or more constraints. A system data store 350 is also arranged to record system data such as assignments and client actions.

The system 300 of FIG. 3 demonstrates how one or more components may be coupled to the system (plugged-in) to enhance its functionality and operate based on the output of the learner 320. Any one of scheduler 310, optimizer 340 and advisor 330 may generate an assignment of a resource to a task based on schedule representation 390 and one or more of these components may form the basis of an implementation of the examples described herein.

In FIG. 3, scheduler 310 is arranged to construct a schedule, i.e. a set of one or more assignments of a resource to a task with associated start times for the performance of each task. Scheduler 310 may comprise sub-functions for one or more of optimizing and maintaining an existing schedule. When constructing a schedule, scheduler 310 may generate data indicative of a number of possible solutions to a set of constraints, e.g. a number of different assignments that are suitable, and may prune or select different sets of possible schedules in the construction of a finalised schedule. In certain implementations, scheduler 310 employs “greedy” heuristics to insert new tasks into an existing schedule which may be initially empty. In this case, for each new task to be inserted, the scheduler 310 validates a limited number of insertion options and choosing those that minimise a cost function. Insertion option validation may be performed “greedily”, i.e. using only the current schedule state since the most recent successful task insertion.

In FIG. 3, optimizer 340 is arranged to receive data representative of an existing schedule as input and then optimizing the existing schedule with respect to a number of specified criteria. For example, the optimizer 340 may take as input data representative of one or more assignments made by scheduler 310 or data representative of one or more manual assignments. In its operation, it may then substitute existing assignments with new assignments to fulfill the specified criteria. Optimization criteria may be based on one or more metrics for resource utilization. As examples, these may include, amongst others: distance travelled by a human resource or a vehicle; a balancing of a task load between resources and/or customers; and a measure of occupancy on task, e.g. resource idleness. Optimization criteria may also be based on one or more metrics for a quality of service. This may involve, for example, assigning resources to tasks with a higher priority in preference to tasks with a lower priority, a task priority forming part of a task profile used as input by the optimizer 340 and assigning tasks such that they are completed within a particular time window. In one implementation, the optimizer 340 performs a computational search in a solution neighborhood around an input or initial schedule; for example, any known optimization algorithm may be used to perform such a local search such as the simplex method, heuristics, statistical methods and iterative methods. Local modifications are made by retracting one or more tasks and reinserting them in different places of the schedule. If tasks are rearranged a scheduler 310 may be invoked to determine assignments for a reordered schedule, or this may be performed by the optimizer 340 itself. After tasks are rearranged, e.g. reordered in time and/or allocated to a different resource, one or more metric values may be generated for the revised schedule. The quality of the revised schedule is measured using a cost function that incorporates the specified metrics. The revised schedule is accepted by the optimizer 340 if its cost is less than the cost of the previous schedule.

Finally, in FIG. 3 advisor 330 is arranged to advise a user of the system 300. The advisor 330 may be arranged to provide guidance to facilitate informed decision making by the user, e.g. via a GUI such as GUI 280B. The advisor can be used to enquire about the scheduling implications of a decision or to help the user to deal with exceptional circumstances. These exceptional circumstances may comprise changes that are required to a schedule of assignments due to unforeseen circumstances or events, such as: late technician sign-up, unforeseen resource unavailability e.g. due to sickness, customer non-attendance or the receipt of one or more new high priority tasks. These unforeseen circumstances may mean that a previously constructed schedule cannot be completed by a resource, leading in turn to, amongst others, one or more of: appointment failure or cancellation; missed task target dates; resource overtime; and insufficient time to travel to task locations. Any of these factors may have an adverse effect on a quality of service provided by an organization or an infrastructure. In these situations a compromise may be required; in particular, constraints for a scheduling problem may need to be relaxed. The advisor 330 is thus configured to determine the effect of a user change on an existing schedule and/or to present alternatives to required changes in a schedule. For example, a user of system 300 may need to manually insert an additional task into a schedule. The advisor 330 is configured to determine whether constraints can still be met following the insertion and whether this change in data now results in a different preferred schedule. As such advisor 330 may invoke, or incorporate, functionality of optimizer 340 and scheduler 310.

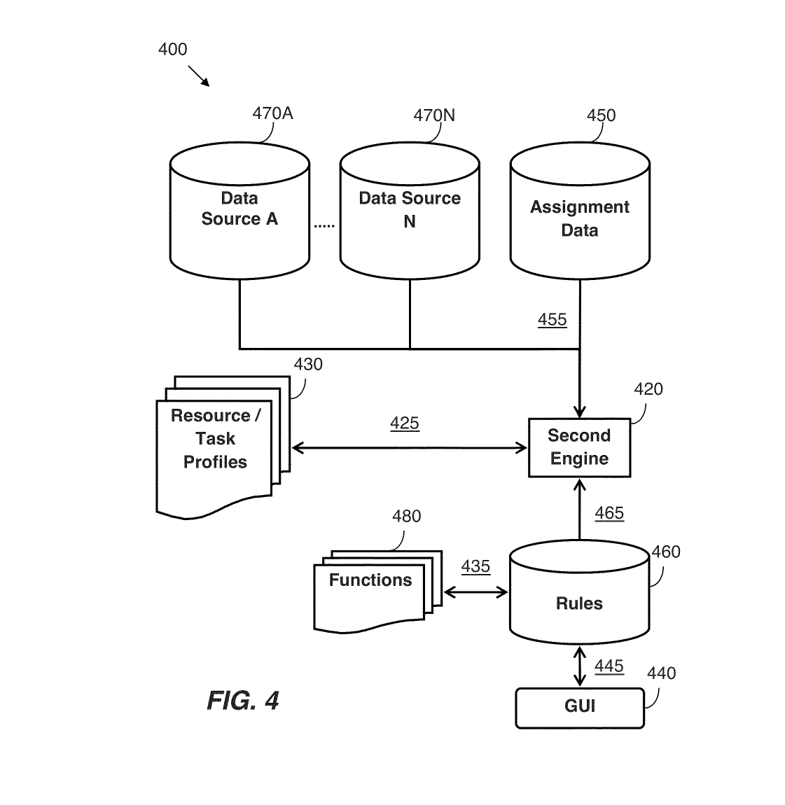

Turning to FIG. 4, the operation of a second engine 420, such as may be embodied by second engine 120, learning component 220 or learner 320, will now be described. As discussed previously, the second engine 420 enables certain dynamically changing characteristics of an asset management system, such as a scheduling system for assigning resources to tasks, to be gathered and embodied in data structures associated with the system. This gathered data can then be used to facilitate more efficient task assignments and the making of better decisions. In certain examples, the second engine 420 operates repeatedly, e.g. either continuously or at regular intervals such as the end of a working day. In these examples, a frequency of operation may be defined based on implementation requirements, such as considerations of practicality and/or an availability of computational resources. At times of operation, the second engine 420 analyzes a current state of the asset management or scheduling system, and maintains a history of previous states. From this analysis, data that informs the operation of the asset management or scheduling system is transformed, updated and stored.

In the example of FIG. 4, the second engine 420 at least updates data associated with a resource that is defined in a resource profile 430. For example, a resource profile may be stored as a data structure and a resource data interface 425 may provide a mechanism for reading and writing data to this data structure. The mechanism may be provided by a standard file system or a bespoke data handler such as that described in relation to schedule representation 290 of FIG. 2. In other cases, the method may be suitably adapted to update data associated with a task that is defined in a task profile 440.

The second engine 420 has access to one or more data sources for use in updating a resource profile 430. In FIG. 4 these comprise N data sources 470 that store data associated with the asset management or scheduling system and assignment data store 450 that stores data representative of one or more assignments of a resource to a task. The assignments stored in assignment data store 450 may be finalised assignments that are for use in constructing a finalised schedule for a resource and/or they may comprise draft or working assignments that have yet to be confirmed or finalised, e.g. assignments generated as part of an optimization or advisory function. Data sources 470A to 470N may comprise, amongst others: log files for resources, such as sensor logs, network equipment logs; audio and/or video data from monitoring systems such as closed circuit television (CCTV) and interactive voice response (IVR) systems; recordings from a location system such as the global positioning system (GPS) or an alternative (e.g. Globalnaya Navigatsionnaya Sputnikovaya Sistema (GLONASS)); static mapping resources such as address records for buildings and equipment; public data resources such as network-published government records on road safety or an ontology (i.e. a defined data model) representing knowledge (e.g. equipment manufacturers and models); and work reports such as those recording the completion of a task recorded by either the human resource performing the task or a customer. The second engine 420 receives data from the data sources over data interface 455. Different interfaces may be provided for different data sources and an interface may provide data conversion and/or pre-processing functions, or alternatively this may be incorporated into the functionality of the second engine 420. For example, a data source 470A may be accessed using one or more of: a Simple Object Access Protocol (SOAP) command for a web service; an API for a locally or remotely processed application or database; or a local or remote file access operation. The data sources need not be permanent storage such as a magnetic disk or a solid state drive; they may alternatively comprise temporary buffers, registers or memory such as those used when passing data over an interface.

The second engine 420 accesses a set of learning rules 460 over a rule interface 465 for use in updating one or more resource profiles 430 using data supplied from one or more of the data sources (e.g. 450, 470). The set of learning rules 460 may comprise one or more functions 480 to be applied to said supplied data to output at least one variable value for a resource profile. In one example, the set of learning rules 460 are defined using the OpenRules standard that is in turn based on the 94^{th} Java Specification Request (JSR94) Java Rule Engine API. In these cases, a function 480 is defined as a logic function in a tabular format, wherein a series of one or more logical expressions or declarations that take as their input the supplied data are defined and one or more variable values are set based on an execution of the logical expression. A variable value for a resource profile may then be set with this output, either directly or after the application of further functions. When using the Java Rule Engine API the second engine 420 may comprise a rule engine for implementing learning rules 460 and may itself be implemented in Java or any other suitable programming language that can make Java API calls. The set of learning rules 460 may be configurable by a user using GUI 440 and configuration interface 445. For an implementation based on the OpenRules standard the GUI 440 and configuration interface 445 may be provided by a spreadsheet or database application. In other cases, the set of learning rules 460 may comprise one or more configurations for one or more machine learning tools. For example, functions 480 may comprise, amongst others, one or more of: clustering tools, support vector machines (SVMs), particle or other digital filters, Bayesian networks, neural networks and genetic or linear programming tools. In this case, functions 480 may comprise library implementations of these machine learning tools, e.g. in C, C++, C#, Java, Python, LISP etc., wherein one or more learning rules 460 supply the operational parameters for these tools and define how input data from the one or more data sources is to be mapped to one or more updated variables in a resource profile. The second engine 420 in this case may be arranged and constructed to implement the mapping.

Whatever implementation is selected, the second engine 420 may be arranged to operate from an initial state where no data is available. For example, this may be a state where there are no assignments yet stored in assignment data store 450 and/or no or only partial data in the other data sources. In this case the second engine 420 may have a bootstrapping mode that operates for a particular time period until a data metric, e.g. a number of assignments stored in assignment data store 450 or a particular number of operational cycles, is met or exceeded.

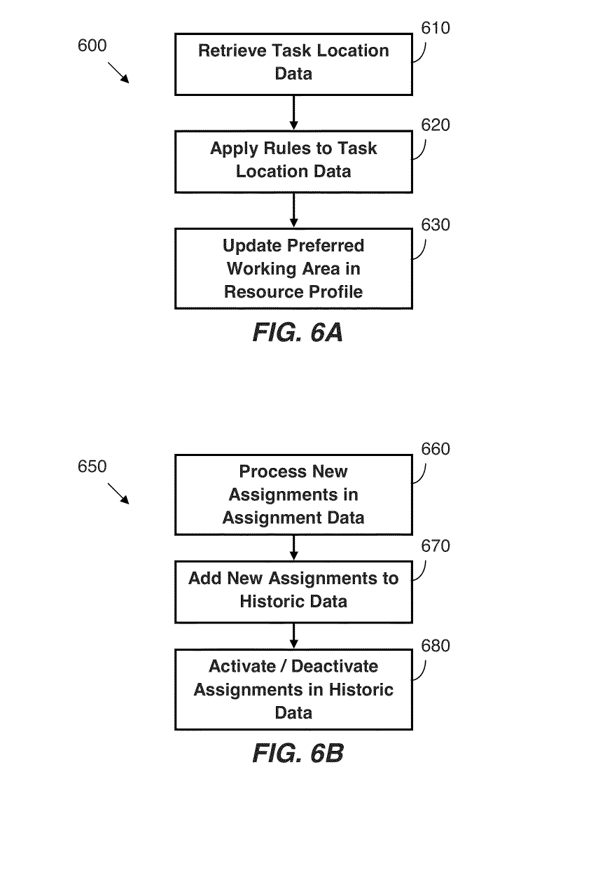

A number of specific rule examples are described later in relation to FIG. 6A onwards. These include: rules that update a preferred working area for a human resource; rules that update a skill level for a human resource; rules that update a task preference for a human resource; and rules that update transport safety variables. By applying these rules, the second engine 420 is arranged to answer the following questions on behalf of a human operator: Which technicians specialize in servicing particular streets or blocks? Which technicians are familiar with a particular geographical area? Which technicians are qualified, and to what degree, to do a particular type of task? Which drivers are safe to be sent to an area with a high number of road accidents? By updating one or more resource profiles 430, a decision making agent, which may be a human expert, an automated service or heuristic rule, can make use of said data and make more informed determinations and implement more efficient scheduling strategies. For example, one or more of scheduler 310, optimizer 340, and advisor 330 (so-called ‘first engines’) may use the updated resource profiles to better schedule, optimize or advise.

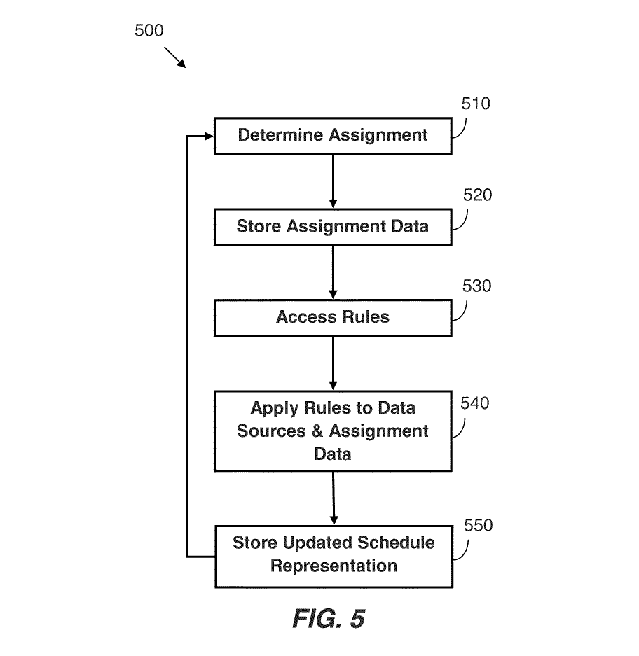

FIG. 5 shows a method 500 of updating a schedule representation according to an example. The method 500 may be implemented in whole or in part by one or more of the systems 100, 200, 300 and 400; however, reference will be made to the components of FIG. 2 for ease of description. At block 510 there is a request to determine an assignment of a resource to a task. This may be, for example, an assignment of a suitable technician to repair an item of equipment, an assignment of a suitable driver and/or vehicle for a delivery or an assignment of a member of staff to complete a customer service query. Block 510 may be initiated based on an instruction to schedule a group of tasks received by the event-driven controller 270 of FIG. 2 from a user via GUI 280B. On receipt of the instruction, the event-driven controller 270 may change its state, e.g. may post a number of appropriate events to be completed by one or more request handlers 260 in an accessible data space (e.g. a virtual ‘notice-board’ or ‘blackboard’). An assignment is made based on at least a comparison of a task profile and one or more resource profiles as described above and below. In one example, if a learning procedure is activated, the event-driven controller 270 also posts one or more events to be processed by learning component 220. These may be detected by the second request handler 260B. These one or more events instruct the learning component 220 to learn from new assignments.

Returning to FIG. 5, at block 520 assignment data associated with the new assignment at block 510 is stored. This may occur automatically or may be performed based on one or more events posted by the event-driven controller 270 for the learning component 220. For example, the second request handler 260 may perform or instruct a number of learning actions, such as updating assignment histories stored in the assignment data store 250 based on the new assignment. In certain implementations, storage of new assignment data may be only temporary, e.g. a first data store may be random access memory (RAM) where new assignment data is temporarily stored before being processed by the learning component 220.

At block 530 one or more learning rules are accessed. These learning rules define how one or more variables of the schedule representation are to be updated based on data associated with the new assignment, which may comprise details of the new assignment itself or data retrieved from one or more data sources based on details of the new assignment, such as other historic data if and when it is available. The one or more learning rules may be the rules described with relation to FIGS. 1 and 4. At block 540, the accessed learning rules are applied to the data associated with the new assignment. This may be performed by learning component 220 based on an instruction from the second request handler 260B. Hence, after any required pre-processing the result of block 540 is to modify an underlying schedule representation comprising one or more resource profiles and/or one or more task profiles. This again may be performed by the learning component 220 and/or by posting other appropriate events to be handled by the event-driven controller 270.

Updating a schedule representation may involve, depending on the rules applied and the implementation, one or more of: updating candidate resource sets for a task, updating preferred working areas for a human resource, updating driver safety indicators, etc. As a result of block 550, an up-to-date schedule representation, such as schedule representation 290, can be used for schedule creation and modifications at subsequent stages of user interaction.

The method 500 of FIG. 5 is an online learning example, i.e. new assignments are processed as they are generated. If an initial instruction is to process or schedule a group of tasks, then block 510 may be repeated one or more times following block 550. In other examples, new assignments may automatically be added to a body of historic assignment data, wherein the body of historic assignment data may be processed offline at particular times, such as at the end of a working day. In particular examples, learning may be based on successfully executed and closed tasks. In this case, a task may be set as “closed” based on feedback regarding the task, e.g. a client may upload and/or enter a task completion report that confirms that the task has been completed successfully. In other cases, a mobile technician that represents the particular resource performing a task may close the task after it has been successfully completed, for example using a mobile terminal. The same mobile terminal may also confirm a location using a positioning system.

An updated schedule representation may be used in a number of ways. When candidate resources for an assignment are presented during an assignment operation, they are based on updated resource profile data. Hence, ‘learned’ information is taken into consideration during schedule construction and/or modification, for example informing specific scheduler heuristics during automatic schedule creation or informing an optimizer during schedule modification. An updated schedule representation may also be used to respond to user queries, for example queries about candidate resource sets for one or more specific tasks. In a particular case, a user may query, e.g. via GUI 280B in FIG. 2, for a set of resources that can execute or perform a particular task. The event-driven controller 270 then returns to the user, via GUI 280B, a set of human resources who have sufficient expertise in executing this type of task and who are experienced in servicing the area around the task's geographic location, this being based on a match made using the updated schedule representation.

A number of specific examples of learning rules will now be described to better understand the operation of the systems and method described above.

FIG. 6A shows a method 600 for updating a preferred working area of a human resource, such as a technician, according to an example. In this example, assignment data, such as data stored in assignment data store 150, 250 or 450, identifies a task and a human resource. In the example of FIG. 6A, a task has an associated geographical location. This may be defined in a task profile, for example as geographic co-ordinate having a latitude variable and a longitude variable. A task's geographic location may be static, e.g. the location of a building, or may be determined dynamically, e.g. based on a tracking or GPS device in a vehicle or equipment associated with the task. If a tasks location is dynamic it may be set as a static value at one or more of a task definition time, a task start time or a task completion time. In certain cases, location data, e.g. from a GPS device, may be used to confirm a task's or a resource's location as defined in a task or resource profile, e.g. from either a positioning device at a task site or from a positioning device associated with one or more resources performing the task such as a mobile terminal or in-vehicle GPS system.

At block 610, during a learning operation, task location data is retrieved. As described above a task location may be retrieved from assignment data or a task profile. Task location data may comprise task locations for a plurality of assignments, such as all assignments for a human resource or a particular set of assignments for a human resource. The latter case is described with relation to FIG. 6B. In certain cases, task location data is retrieved by running a database query on data stored in an assignment data store with a particular resource identifier as a parameter. Task location data may comprise a plurality of geographic co-ordinates and these may be stored in memory or a temporary data structure during the process. At block 620 one or more learning rules are applied to the task location data to generate a definition of a preferred working area. The one or more learning rules may comprise rules defining the generation of a geographical area definition from a union of areas represented by the task location data. In a simple case, a preferred working area may comprise a geographical area defined by a union of one or more circles that have a centre at a task location and a predetermined radius. Each radius may be preset, for example a set distance or set driving time, or may be set based on other data, such as a defined confidence level of a human resource. In more advanced cases, more complex geometric and/or geographical operations may be used, such as unions of zip or postal code areas. For this purpose bespoke or third party topology libraries can be used such as Java Topology Suite (JTS). At block 630, the generated preferred working area for a particular human resource is identified in the resource profile for the particular resource. For example, a preferred working area may comprise an array of a plurality of geographical co-ordinates, with an area enclosed by the co-ordinates defining the preferred working area, or one or more postal or zip codes, or a link or pointer to a mapping resource or networked area definition. After the method 600 is complete, a next resource in a set may be selected and blocks 610 to 630 repeated to update the resource profile of the next resource. In certain cases, the method 600 is applied during the processing of a set of completed tasks, in which case resources are selected, and resource profiles retrieved, based on one or more resources that performed (or were otherwise associated with) each completed task in the set.

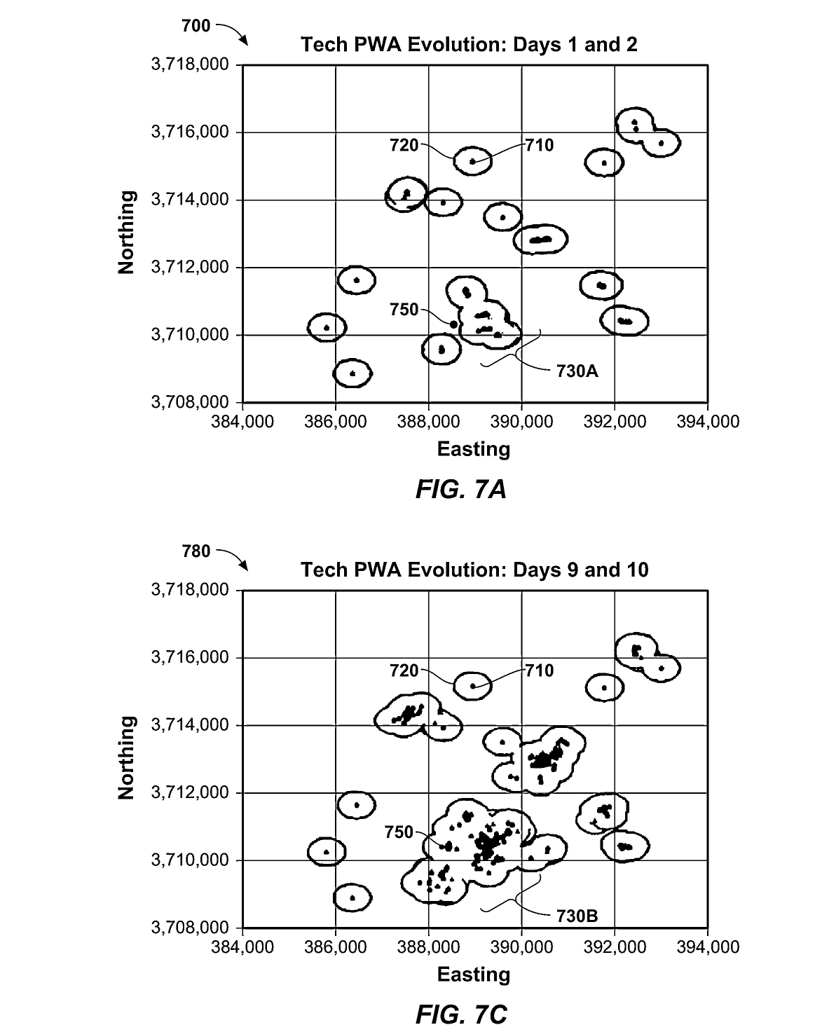

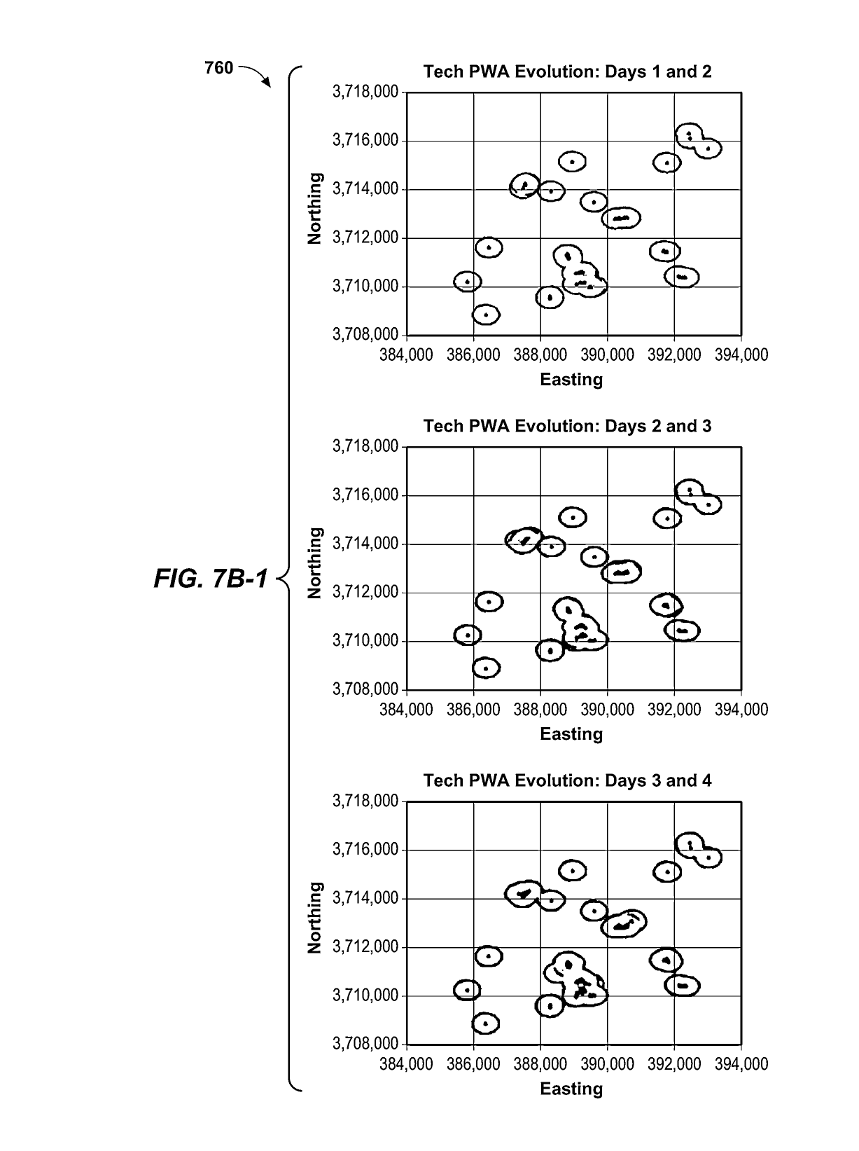

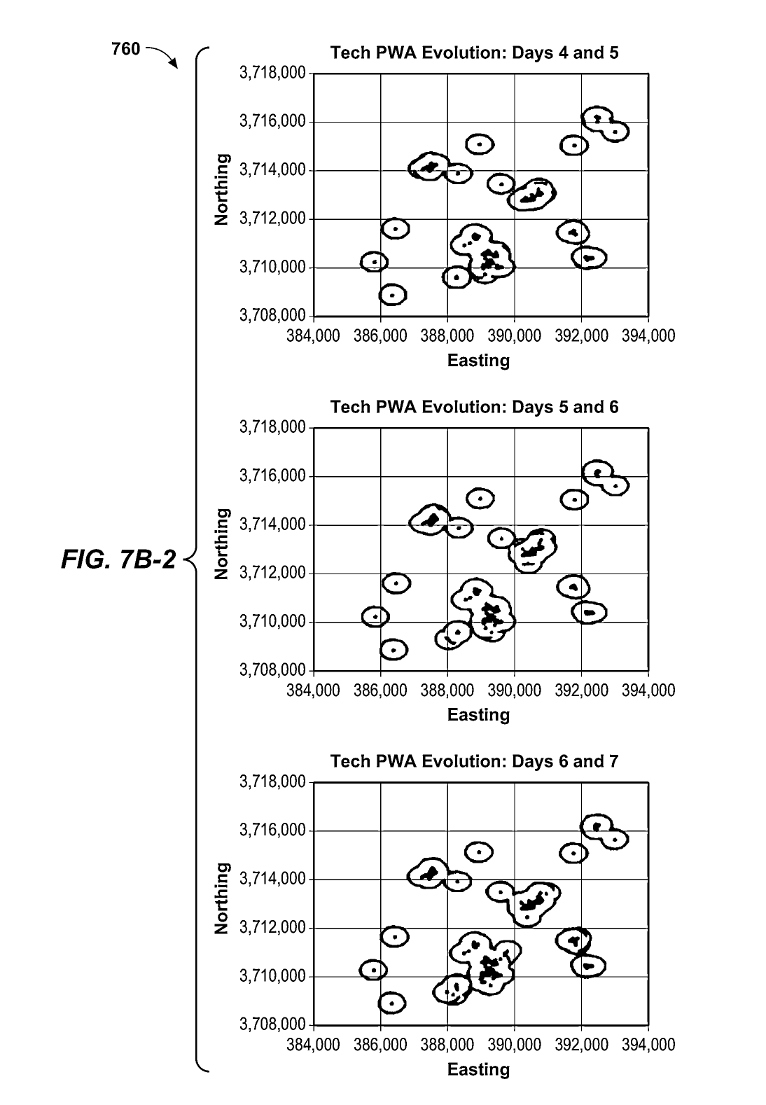

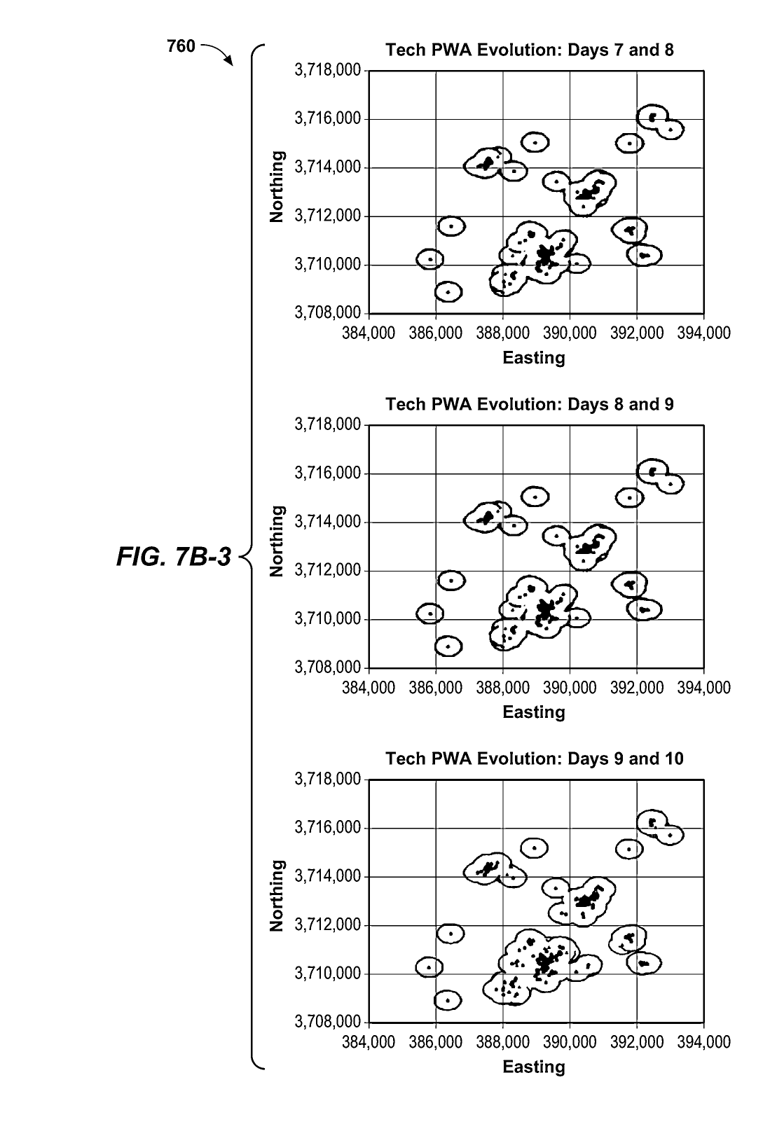

FIGS. 7A, 7B and FIG. 7C show how a definition of a preferred working area for a particular resource may change over a period of time. Chart 700 shows a representation of task location data for a particular resource after a period of two days learning. Task location data comprises a plurality of task location co-ordinates 710 (defined here by a Northing and Easting value). As part of block 620, a task area 720 is defined for each of the plurality of task location co-ordinates 710. In certain sections of FIG. 7A, the task areas 720 are adjacent and as such are merged to form a conjoined task area 730A. FIG. 7A also shows an example of a new task location 750 that will be used to show how a preferred working area is used to inform future assignments of the particular resource to a task. In FIG. 7A it may be seen that new task location 750 is outside task areas 720 (e.g. is outside of conjoined task area 730A). Hence, if the definition of a preferred working area represented in FIG. 7A was accessed when generating a set of candidate resources for a task to be assigned, the particular resource would be excluded from the set of candidate resources as new task location 750 resides outside of the definition of a preferred working area (i.e. outside of an area defined by task areas 720).

FIG. 7B shows a series of charts 760 representing the change in the definition of the preferred working area for the resource over a number of days. Each day the particular resource, which may be a network technician, completes a number of tasks that have been assigned. As the tasks are completed successfully, a body of assignment data associated with the particular resource increases in size. This in turn means that the number of data points representing task locations 710, and corresponding task areas 720, increases leading to a more accurate definition of the preferred working area for the resource.

FIG. 7C shows a chart 780 representing task location data for a particular resource after a period of ten days learning. As can be seen, the chart has more task locations 710 than FIG. 7A and a plurality of conjoined areas have developed representing areas regularly frequented by the resource when performing tasks. The conjoined task area 730A from FIG. 7A has now grown to become conjoined task area 730B that now encompasses new task location 750. Hence, after 10 days the resource would be included in the set of candidate resources to perform the task. FIGS. 7A to 7C show a benefit of learning: resources can be more efficiently matched with tasks, in this case tasks in locations in which the resource has demonstrated that it is capable of performing tasks. This leads to an increase in efficiency and has a particular benefit when the resource is human, since tasks in familiar locations are more likely to be completed successfully and quickly as the resource has knowledge of the local area and conditions, which are often difficult to easily and/or efficiently formalise for processing by a computer system.

FIG. 6B shows a method 650 that may be applied as a variation of the method 600 of FIG. 6 to increase accuracy. As before, the blocks described below may be performed by at least a second engine or its system implementations. In method 650, the set of assignments from which task location data is to be retrieved is restricted and it is assumed that only active assignments are used to update the preferred working area of a resource, as explained below. This effectively prunes certain areas from a set that is used to generate the preferred working area. For example, the method 650 of FIG. 6B may be applied to exclude older task locations, i.e. based on assignments marked as inactive, to ensure the relevancy of the preferred working area for a resource, or may be applied to exclude outlying data points, i.e. those outside of a cluster of locations of a given size. For example, this may be applied if a human resource is providing temporary cover outside of a normal working area or is on a training course.

The method 650 of FIG. 6B may be applied where assignment data further comprises a timestamp, representing the time and/or date the assignment was made, and a state. The timestamp may comprise a long integer equal to the system time in seconds at a moment an assignment is made or at a moment when an assignment is processed as part of a learning procedure subsequent to assignment. The assignment data may also comprise an age, or the age may be calculated dynamically from the timestamp and a current system time. In the example of FIG. 6B, a state of an assignment is used to determine whether an assignment, and by extension its associated task location data, is to be included in the calculation of a preferred working area; e.g. an active state reflects that an assignment is to be used to determine a preferred working area while an inactive state reflects that an assignment is not to be used to determine a preferred working area.

At block 660 in FIG. 6B new assignments are processed. This may be performed at set times when learning is periodic or may be performed whenever a new assignment is detected, e.g. is posted via the event-driven controller 270. In the former case, block 660 may be performed based on a list identifying new assignments that have been made since a previous operation of a second engine or learning component. In an initial or bootstrapped mode there may be no new assignments. New assignments may be subject to one or more learning rules that set the state of the assignment in the assignment data. For example, the state of an assignment may be based one or more of: a number of assignments recorded in total for a particular resource and a number of adjacent assignments. In this case, a pair of assignments Aᵢ and Aⱼ are said to be adjacent if, and only if, a straight line Euclidean distance between associated task locations TLᵢ and TLⱼ does not exceed a specified threshold (a similar calculation may be used when defining location clusters for scheduling tasks). In a specific implementation a first bootstrapping rule may be applied, e.g. if a number of assignments in an assignment history is less than a particular value, such as 10, all assignments should be marked as ‘active’. When enough data exists, an additional set of rules may stipulate that when an assignment history contains a particular number of assignments, e.g. 10 assignments or more, the state of a current assignment is set to ‘active’ if it has more than 3 adjacent assignments. Otherwise an assignment state is set to ‘inactive’. In this case, an assignment history may comprise assignment data stored in one of assignment data stores 150, 250, 350 or 450. An assignment history in this case may only include completed tasks. In cases where assignments are repeated, e.g. where a resource may perform a task every month, two assignments with a common name may be distinguished by a timestamp in the respective assignment data.

After block 660, one or more new assignments that were processed in block 660 are added to an assignment history. Hence, stored assignment data representing historic or processed assignments comprises completed state allocations.

In FIG. 6B, after new assignments have been added to an assignment history, information regarding the assignments that were added in block 670 needs to be propagated through existing assignments forming part of the assignment history. For example, rules based on characteristics of other assignments, e.g. a number of assignments or adjacent assignments, may need to be reapplied after new assignments have been added to the assignment history. As part of block 680, one or more learning rules to be applied implements an aging of historic data, i.e. data over a certain age is not considered in an update of a resource profile. In this example, assignment data further comprises an expiry variable, which may be Boolean wherein ‘true’ represents an expired assignment. An assignment expires once its age, e.g. a time as calculated using an assignments timestamp, is greater than a certain threshold. The expiry variable may be set to ‘false’ at block 670, when a new assignment is added to an assignment history. In certain examples, expired assignments never change their state and as such, once they are marked ‘inactive’, are not used again in the update of a resource profile.

Returning to FIG. 6B, one learning rule that may be applied as part of block 680 comprises activating inactive assignments that have not yet expired. For example, this may occur when, due to newly added assignments, the number of adjacent assignments increases above a predetermined threshold. In one case, the learning rule activates an assignment, i.e. sets its state to ‘active’ within assignment data. A set of example conditions for this rule may be: 1) the assignment has previously been inactive, i.e. initial state=“inactive”; 2) a number of adjacent assignments is above a predetermined threshold (e.g. >3); and 3) the assignment has not expired, i.e. it has a ‘false’ expiry variable.

A further learning rule that may be applied as part of block 680 deactivates active assignments that have now expired. This, as well as the rule described above, represents a form of maintenance for the assignment history. In one implementation, a particular assignment in the assignment history is deactivated if a state of the assignment is active, the number of assignments recorded in the assignment history is greater that a first threshold, and an age of the assignment is greater than a second threshold. As an example the first threshold may be 50, representing an assignment history comprising 50 assignments and/or the second threshold may be 90, presenting an age of at least 90 days. Assignment deactivation may be relevant in stable circumstances whereby data used for scheduling has a low rate of change. In this case, a second engine or learning component may safely consider only a short period of the recent history without any adverse effect on representation accuracy.

The method 650 of FIG. 6B may be applied before performing the blocks of method 600 shown in FIG. 6A. Additionally, the methods of aging or maintaining assignment data described above may also be applied to other examples, for example to limit the application of a set of rules or learning tool as implemented by a second engine to a subset of assignments such as a subset of assignments as stored in an assignment data store.

Certain examples described herein facilitate data setup and maintenance by providing an infrastructure for integrated learning of dynamic characteristics of a scheduling system. In certain described examples, decisions that allocate or assign resources to a task in a particular area are processed to update a preferred working area for a resource. This allows for better use of a ‘local knowledge’ of a workforce, in turn helping to ensure the timeliness and appropriateness of automatic and/or suggested responses to scheduling challenges on a daily basis. By updating data defining one or more characteristics of a resource to be assigned, a system may provide efficient proactive and reactive jeopardy management and exception handling. Updating variables relating to the skills and preferences of a resource based on tasks that have been previously assigned to the resource improves job execution quality and resource utilization. For example, this may be achieved by directing highly-qualified personnel exclusively to the work requiring scarce skills. By treating rare and common skills differently in certain examples of a learning methodology, flexible resource allocations schemes are possible whereby resources with rare skills are reprioritized such that they are only used to execute jobs requiring scarce skills.

FIG. 8 shows a method 800 for updating variables representative of a human resource's skills and/or preferences according to an example. The method 800 may be applied for a particular resource and may be iterated for different resources.

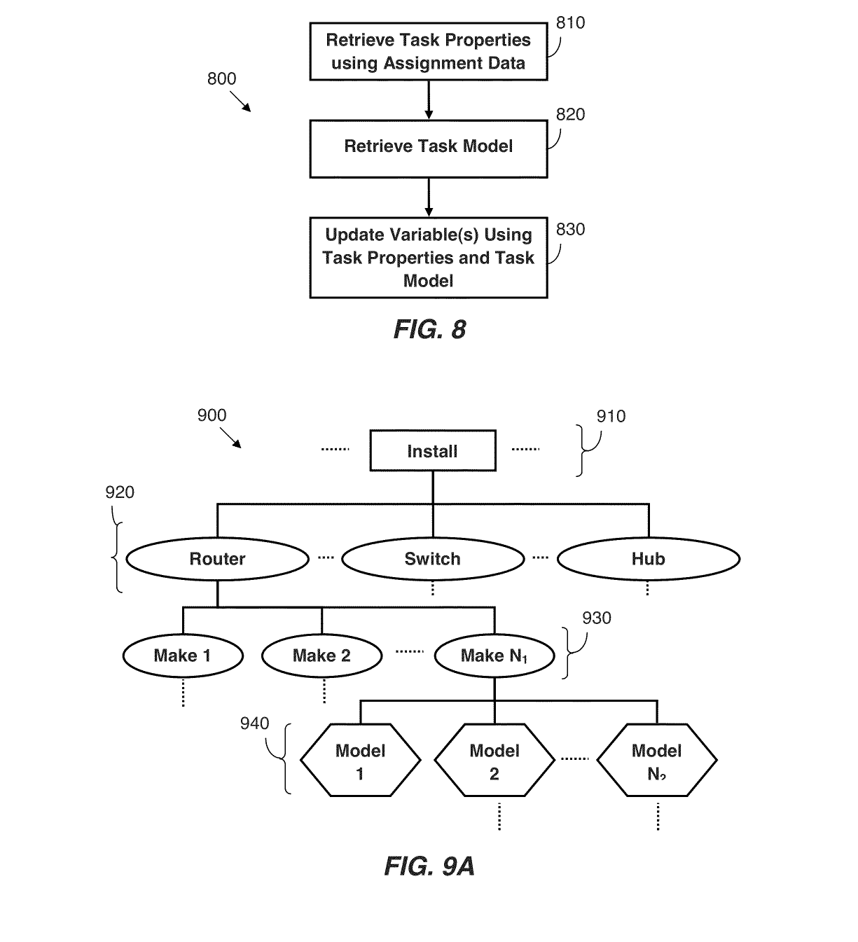

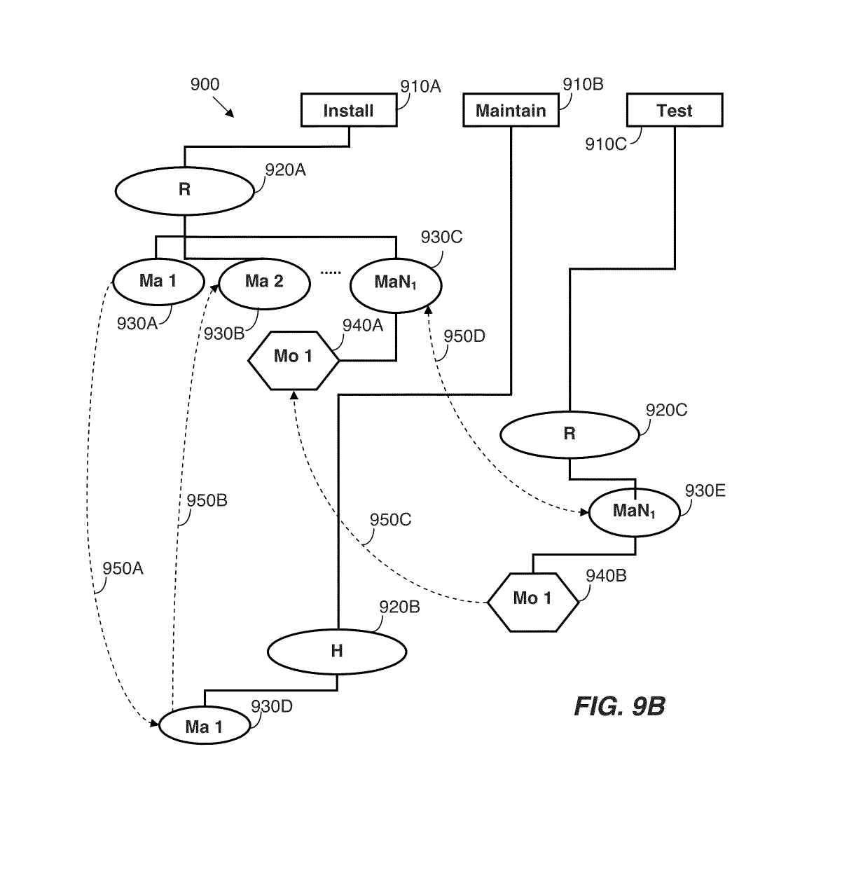

At block 810 task properties are retrieved using assignment data. In one implementation, an assignment, as represented by data stored in assignment data store 150, 250, 350 or 450, identifies a task, for example by using a unique task identifier. This then enables a task profile to be retrieved using the unique task identifier. The task profile then sets out, either directly or via links and/or pointers, task properties for a task. In another implementation, the task properties may be determined and stored as part of the assignment data. At block 820 a model of skills required for the execution of a task is retrieved, hereinafter referred to as task skill model. The task skill model may comprise system data that is stored as part of a schedule representation. A task skill model defines one or more relationships between task properties. An example is shown in FIGS. 9A and 9B and will be later described. At block 830, the retrieved task skill model is applied to the retrieved task properties during the application of one or more learning rules in order to update one or more variables of a resource profile. For example, a retrieved task skill model may indicate a relationship between a first task property and a second task property. A variable in a resource profile may relate to a first task property. During block 830, any occurrence of the second task property in the assignment data may be used to update the variable in the resource profile that relates to the first task property, as set out by the relationship defined in the task skill model. This process will be explained in more detail below in relation to a specific example.

FIG. 9A shows a task skill model 900 according to an example. In this example, the task skill model is a hierarchical structure wherein parent nodes represent certain classes or categories and child nodes represent specific embodiments of a class or category. A first level of task skill model 900 sets out a number of task types 910. The dotted lines in FIG. 9A indicate the possibility of further items in each level that are not shown for clarity. In the example of FIG. 9A, a shown task type is ‘install’, representing the installation of equipment, such as an item of computing or telecommunications hardware. Other possible options may comprise: ‘maintain’, representing the maintenance of equipment; ‘repair’, representing the repair of equipment; and ‘test’, representing the testing of equipment, to name just a few. A second level of task skill model 900 provides sub-categories for each task type, representing an equipment type 920. Three equipment types are shown as an example in FIG. 9A: ‘Router’, ‘Switch’ and ‘Hub’. More equipment types may be provided. A third level of task skill model 900 comprises a sub-category of equipment type representing an equipment manufacturer 930 (e.g. ‘Acme Routers’, ‘Hubster’ etc). In FIG. 9A each equipment type 920 may have between 1 to N₁ equipment manufacturers 930. Finally, a fourth level of task skill model comprises a sub-category of equipment manufacturer 930 representing a particular equipment model 940 (e.g. ‘100 series’, ‘NSF500’, ‘BlueA’). In FIG. 9A each equipment manufacturer 930 may have between 1 to N₂ equipment models 940. N₁ and N₂ will typically have different values but in certain cases may have equivalent values.

The task skill model of FIG. 9A is provided for example only. Other task skill models may have one or more levels with different categories and sub-categories. A task skill model may be presented in any programming language that enables hierarchical models, for example one of the many mark-up languages or a language that allows class abstractions and inheritance.

The task skill model 900 shown in FIG. 9A may be used in one or more learning rules that represent the acquisition of experience by a resource. In one example, the one or more learning rules comprise one or more skill acquisition rules for a human resource, such as a rule defining that a skill level value is proportional to a number of performed tasks associated with the skill level. In this case, a performed task may comprise a satisfactorily or successfully executed, e.g. closed, task, for example as rated in user feedback following task completion. In an example, a resource profile for a human resource, such as a technician, has a tabular data structure that represents a set of skills levels, wherein a particular entry in the tabular data structure corresponding to a skill level may have an integer value in a predetermined range (e.g. 0 —no experience to 5—expert). The tabular data structure may comprise entries for one or more skill levels corresponding to equivalent levels in the task skill model 900.

In an example, a task profile defines as least one of a first level category 910 and a second level category 920 as a task property. This task property is then associated with an assignment in the assignment data. For example, a task may be ‘install.Router’ or ‘test.Hub.Ma1’. In this example, a resource profile for a human resource such as a technician has a corresponding resource variable representing a skill at a particular level. For example, a resource may have a skill variable for the first level category ‘install’, representing installation of all equipment, and/or for a sub-category level such as ‘test.Hub.Ma1’, representing a skill in testing hubs from a first manufacturer. During a learning procedure for a particular human resource, a number of assignments performed by the human resource for each skill variable category is counted; for example, for a skill variable for ‘install’ (Skill.install), the number of assignments that have at least at associated first level category of ‘install’ may be counted. The set of assignments used in the count may be restricted as described, for example in relation to FIG. 6B above. An ‘install’ skill level may then be set using a learning rule that defines a number of bins relating to the number of counted assignments. For example, if the number of assignments featuring tasks with a task property of at least ‘install’ (e.g. ‘install.*) falls within 6 to 10 and a skill level is currently less than 2, then the skill level may be set to 2 (e.g. skill.install=2). Likewise, if the number of assignments featuring tasks with a task property of at least ‘install’ (e.g. ‘install.*) falls within 11 to 20 and a skill level is currently less than 3, then the skill level may be set to 3 (e.g. skill.install=3). Further conditional statements may be defined for other skill levels and other categories and sub-categories.

Another learning rule may define how parent skill levels are calculated based on child skill levels. For example, a learning rule may first update a skill level at a lowest level in the hierarchical task skill model (e.g. level 940 in FIG. 9A) and then propagate skill level values up the hierarchy. Parent skill levels may be set, for example, based on average child skill levels or by taking a maximum or minimum value of a particular child skill level in accordance with a particular logic rule.

Referring to the examples in the Figures, a skill level for testing a particular model of hub, ‘test.Hub.Ma1.Mo1’, may be set in a similar manner to the rule above by counting a number of assignments in a set of assignment data (e.g. assignments that have been added to an assignment history as described in relation to FIG. 6B) that relate to tasks that have a task property of ‘test.Hub.Ma1.Mo1’ (e.g. the task comprises tests a Mo1 hub). A skill level value for a parent node may then be calculated by averaging one or more child skill level values. For example, a skill level value for ‘test.Hub.Ma1’ (testing of hubs supplied by a first manufacturer) may comprise an average of N₂ skill level values for ‘test.Hub.Ma1.Mo1’ to ‘test.Hub.Ma1.MoN₂’, a skill level value for ‘test.Hub’ may comprise an average of N₁ skill level values for ‘test.Hub.Ma1’ to ‘test.Hub.MaN₁’, and a skill level for ‘test’ may comprise an average of skill level values for each equipment type (e.g. ‘test.Router’, ‘test.Hub’ . . . to ‘test. Switch’).

FIG. 9B shows a number of relationships between different elements of a task skill model 900. For ease of explanation, certain categories and sub-categories have been added and omitted; as such it should be understood that FIG. 9B may only represent a portion of a complete task skill model 900. FIG. 9B shows three first level categories: ‘install’ 910A, ‘maintain’ 910B and ‘test’ 910C. Category ‘install’ 910A has a sub-category ‘R’ (for ‘Router’) 920A. This sub-category ‘R’ 920A has a number of child nodes representing equipment manufactures ‘Ma 1’ 930A, Ma 2’ 930B and ‘Ma N₁’ 930C, wherein child node ‘Ma N’ 930C acts as a parent node for equipment model node ‘Mo 1’ 940A. Category ‘maintain’ 910B has a sub-category ‘H’ (for ‘Hub’) 920B. This sub-category ‘H’ 920B has a child node representing and equipment manufacture ‘Ma 1’ 930D. Category ‘test’ 910C has a sub-category ‘R’ (for ‘Router’) 920C. This sub-category ‘R’ 920C has a child node representing and equipment manufacture ‘Ma N₁’ 930E, which in turn has an equipment model node ‘Mo 1’ 940B.

FIG. 9B also illustrates four relationships that may be defined as part of the task skill model. A first relationship 950A connects node ‘Ma 1’ 930A (i.e. install.R.Ma1) to node ‘Ma 1’ 930D (i.e. maintain.H.Ma1). The first relationship 950A may represent how experience gained with regard to installing router equipment from a first manufacturer is transferrable to maintaining hub equipment from the same first manufacturer. A second relationship 950B connects node ‘Ma 1’ 930D (i.e. maintain.H.Ma1) to node ‘Ma 2’ 930B (i.e. install.R.Ma2). The second relationship 950B may represent how experience gained with regard to maintaining hub equipment from a first manufacturer is transferrable to installing router equipment from a particular second manufacturer, e.g. the first and second manufacturer may use a common control firmware. A third relationship 950C connects node ‘Mo 1’ 940B (i.e. test.R.MaN₁.Mo1) to node ‘Mo 1’ 940A (i.e. install.R.MaN₁.Mo2). The third relationship 950C may represent how experience gained with regard to testing a first model of router equipment is transferrable to installing the same equipment. A fourth relationship 950D connects node ‘Ma N₁’ 930C (i.e. install.R.MaN₁) to node ‘Ma N₁’ 930E (i.e. test.R.MaN₁). The fourth relationship 950D is shown as bi-directional, i.e. experience gained with regard to testing router equipment for a manufacturer is transferrable to installations of routers for the same manufacturer and vice versa. The relationships shown in FIG. 9B are to be understood as examples only and many other skill relationships that are not shown are possible.

The relationships shown in FIG. 9B may be defined as part of the task skill model or in relation to the task skill model. A learning rule to be implemented by a second engine may refer to the relationship as defined using the task skill model. For example, one or more learning rules for updating skill levels directly based on a number of successfully-executed tasks associated with the skill level may be used together with one or more learning rules for updating skill levels in a first category or sub-category indirectly based on performed tasks in a second category or sub-category, the relationship between the first category or sub-category and the second category or sub-category being set by a relationship similar to the ones illustrated in FIG. 9B. Both direct and indirect updating may be based on a pre-processing stage whereby, for a particular resource, a number of assignments associated with tasks in each category and/or sub-category is counted.

In a first example of a learning rule applying indirect updating of skill levels, the first relationship 950A shown in FIG. 9B may define that a particular resource-profile skill level value for ‘maintain.H.Ma1’ is updated based on a resource-profile skill level value for ‘install.R.Ma1’. This may be performed after a first stage of direct updating as described above. For example, a particular rule may comprise: ‘IF install.R.Ma1 IS 3 AND maintain.H.Ma1 IS 1 THEN maintain.H.Ma1=2’. In a similar manner, the second relationship 950B shown in FIG. 9B may relate to a rule such as ‘IF maintain.H.Ma1>3 THEN install.R.Ma2=>1’. Other learning rules may represent relationships such as: repair proficiency for one manufacturer increases installation proficiency for the same manufacturer or once a technician achieves a particular skill level at maintaining a router from a first manufacturer their skill level for repairing routers for another manufacturer can be raised. These learning rules may be referred to as propagation rules, as skill values are propagated through a resource profile. In certain cases propagation rules may be chained, such that the completion of one propagation rule triggers the activation of another propagation rule. Propagation finishes when a fixed point is reached where no more skill level changes can be made.

In a similar manner to the aging of assignment data described previously, e.g. with regard to FIG. 6B, one or more learning rules may also set out how a skill level of a human resource changes with time. In one case, a skill level corresponding to any one of the levels in the task skill model 900 may reduce over time if a human resource is not assigned to a particular type of task over a specified minimum period of time. For example, if, for a particular resource, there is a gap of a predetermined number of days between consecutive assignments to a particular type of task, then the skill level for that particular type of task in the resource profile for the particular resource is reduced. The predetermined number of days may for example be 30 days and may be measured by a learning rule that operates on an assignment timestamp and/or age. In one case, the lower the skill level the greater the reduction in skill level following a gap; e.g. after a gap of 30 days without being assigned to install a router for a first manufacturer, a previous ‘install.R.Ma1’ skill level of 5 may be reduced to 4 and a previous ‘install.R.Ma1’ skill level of 4 may be reduced to 2. Skill reduction learning rules may be applied before a propagation learning rule as described above, such that a reduction in a skill level is propagated through skill levels. Skill reduction and skill acquisition learning rules may be applied together at one level of the task skill model, i.e. to one set of entries in a tabular data structure in a resource profile, before further application at a higher level of the task skill model, such that acquired and/or reduced skill levels for child nodes are propagated up a hierarchy to parent nodes.

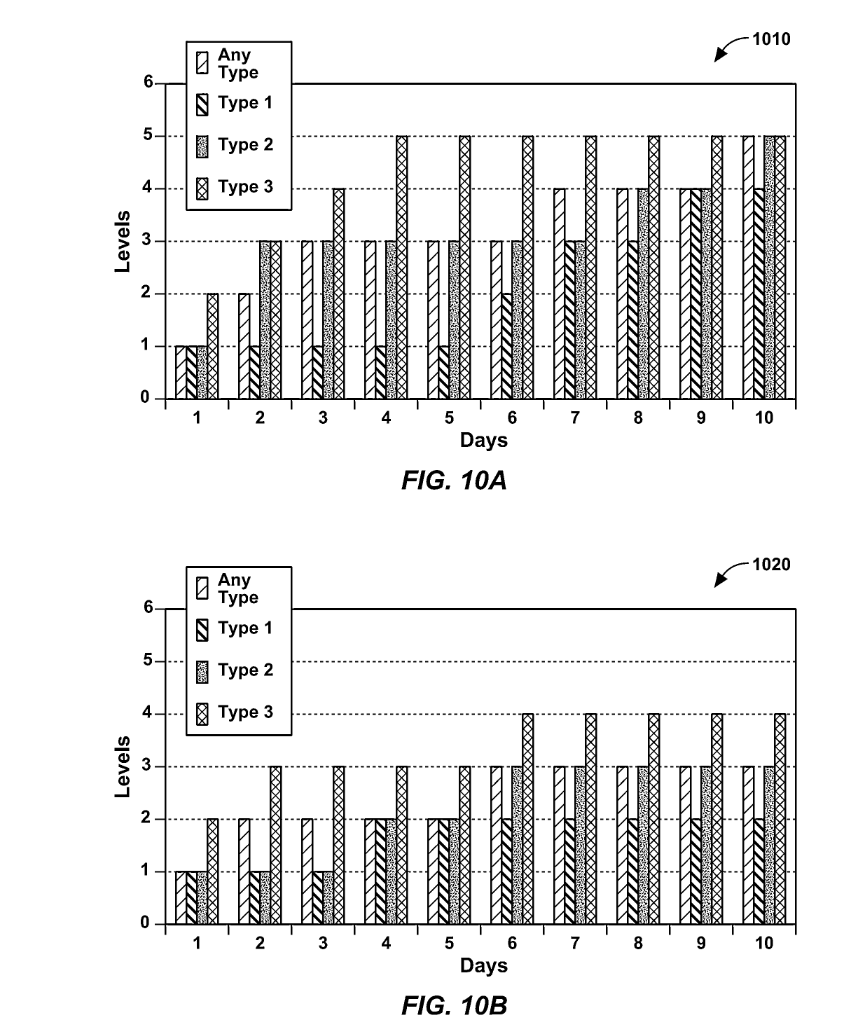

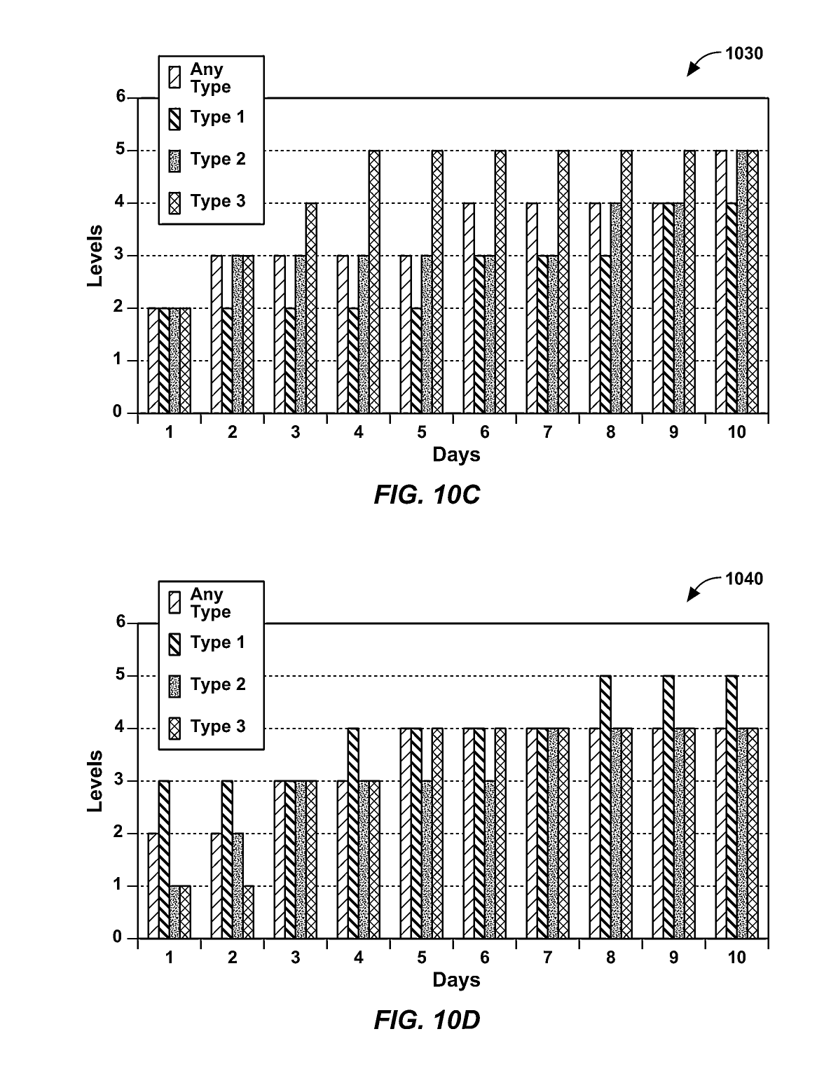

FIGS. 10A to 10D show the effect of the learning rules for modifying a particular resource's skill levels as described above. FIG. 10A shows a chart 1010 illustrating four skill levels for the particular resource. In this example, the skill levels represent a number of ‘install.R’ skill levels: a skill level of the particular resource for all manufacturers (e.g. ‘install.R’ or ‘Any Type’); a skill level for a first manufacturer (e.g. ‘install.R.Ma1’ or ‘Type 1’); a skill level for a second manufacturer (e.g. ‘install.R.Ma2’ or ‘Type 2’); and a skill level for a third manufacturer (e.g. ‘install.R.Ma3’ or ‘Type 3’). In a similar manner, FIG. 10B shows a chart 1020 illustrating four skill levels of the particular resource for a ‘maintain.R’ group; FIG. 10C shows a chart 1030 illustrating four skill levels of the particular resource for a ‘repair.R’ group; and FIG. 10D shows a chart 1040 illustrating four skill levels of the particular resource for a ‘test.R’ group.

FIGS. 10A to 10D show how skill levels change over a time period (10 days). The time period shown in the Figures is too short for a set of skill reduction rules to apply (e.g. if they apply the above-mentioned 30-day gap rule); however, in a practical implementation over a period of 60 days or more both acquisition and reduction of skill levels based on assignments over that time period would likely be observed. As is also illustrated in the Figures the skill levels representative of all manufacturers (‘Any Type’) on a particular day are taken to be an average of the three children nodes (‘Type 1’, ‘Type 2’ and ‘Type 3’), which may be rounded-up to a nearest integer value. In these examples it has been found that taking into consideration indirect skill learning rules leads to dynamic adaptation of skill levels, and more accurately models the development of skill by a human resource. Hence, when the skill levels are used to match a task to a resource for an assignment, technicians which are available but have been previously overlooked by an asset management or scheduling system can now form part of a set of candidate resources.

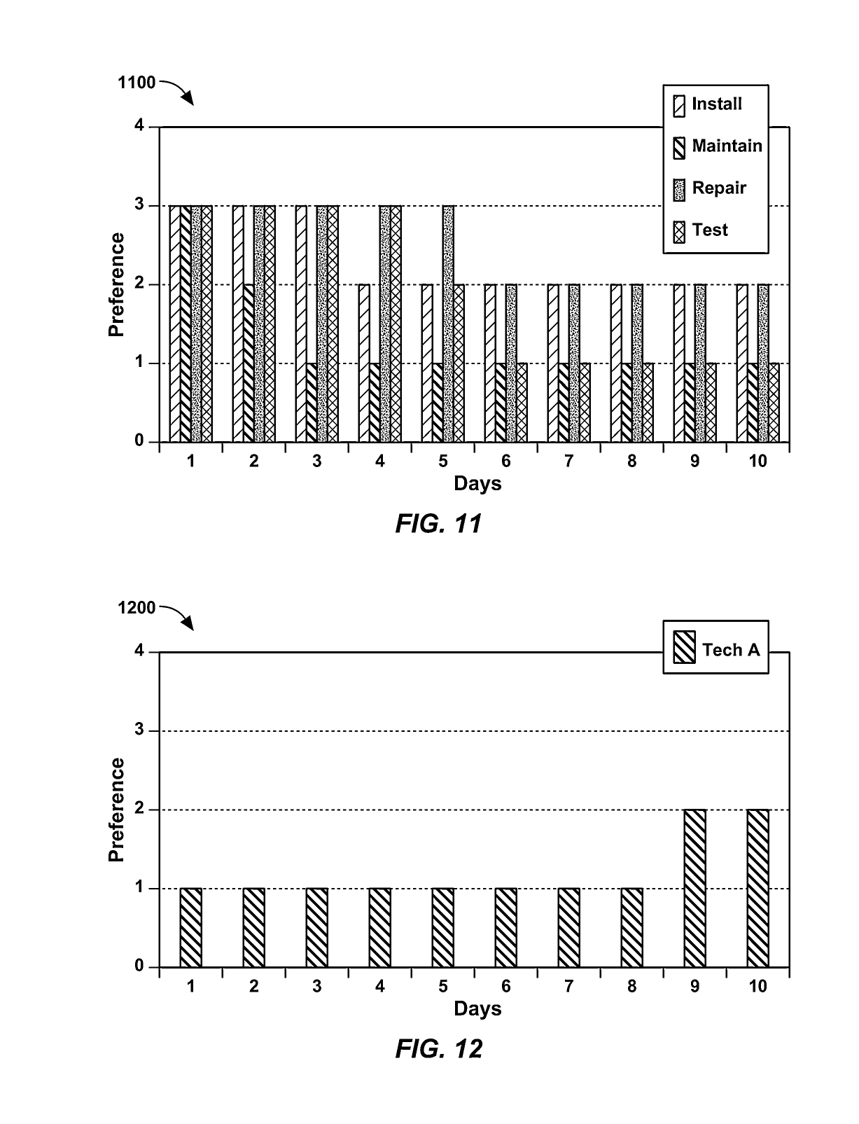

Another set of learning rules that may operate based on task properties are those that update preference variables in a resource profile. These preference variables represent a preference of a human resource, e.g. a technician, and enable efficient matches to tasks to be made. In an example described herein there are three preference levels, ‘low’, ‘medium’ and ‘high’. These may be represented by a string value or, as shown in FIGS. 11 and 12, respective integer values of 1, 2 and 3. The example is used for ease of explanation and, as stated previously, other implementations are possible (e.g. different ranges and/or values for preference variables). Two sets of preference learning rules will now be described. These may be complementary.

A first set of learning rules configure a workforce-centric preference. This, for example, sets a preference variable corresponding to one or more of the levels and/or nodes shown in task skill model 900. This modifies a preference variable for a particular level or node depending on the number of assignments to tasks associated with the level or node. In one case, it is assumed that a preference of a human resource for a particular type of task reduces as his experience in the type of task grows. This may reflect the need for resources to have a wide variety of experience, i.e. to perform a variety of task types, and/or that having a low preference leaves a skilled technician available for more complex tasks.

FIG. 11 shows preference levels for a resource profile of a particular resource. The preference levels correspond to the first level of the task skill model 900, i.e. reflect ‘install’, ‘maintain’, ‘repair’ and ‘test’ task types. Chart 1100 shows how the preference levels for each node in the first level of the task skill model 900 change over a period of 10 days. As can be seen in the Figure, a preference variable value for each node is initialised to ‘3’ (i.e. ‘high’). The preference variable value for each node then degrades over time as the number of executed tasks of that type to date increases.

A second set of learning rules configure a workload-centric preference. This, for example, sets a preference for tasks requiring scarce skills as high if a human resource, such as an engineer or technician, possesses the required scarce skill. This preference variable may then be used in the assignment of a resource to a task to ensure that resources with scarce skills are spared for tasks that require skills that are scarce.

A task type may be defined as scarce if it represents less than N % of a daily workload, wherein N is a configurable threshold (e.g. 5). According to a first learning rule, assignment data is analyzed to determine if any count values for task types associated with assignments fulfil the scarcity metric condition. For example, a particular level of the task skill model 900 may be selected and for a predetermined time period an average proportion for each node in the particular level may be calculated. Referring to the example task skill model 900 of FIGS. 9A and 9B, the second level may be selected such that average daily proportions are calculated for: ‘install.R’, ‘install.H’, ‘install.S’, ‘maintain.R’, ‘maintain.H’, ‘maintain.S’, . . . ‘test.R’ . . . etc. If any of these have average daily proportions below N % they are classed as ‘scarce’. For example, ‘test.R’ may have an average daily proportion of 2% and so the testing of routers is classified as a ‘scarce’ task type. This may be recorded in the afore-mentioned schedule representation, for example as part of system data held in data store 250, 350. In other examples, different scarcity metrics may be defined, e.g. less than M % of a monthly task type proportion or an average gap between tasks of L days.

After a scarcity metric has been defined and potential scarce task types identified, a workload-centric preference for a resource representing a propensity for scarcity is set. In one case, a second learning rule may set a particular workload-centric preference if a skill level corresponding to a scarce task type is in a given range. Returning to the example above, a condition may comprise that a skill level corresponds to a scare skill type, e.g. skill level=test.R, and that: if the skill level value is less than or equal to 2 the workload-centric preference is ‘low’ (e.g. ‘1’); if the skill level value is 3 the workload-centric preference is ‘medium’ (e.g. ‘2’); and if the skill level value is greater than or equal to 4 the workload-centric preference is ‘high’ (e.g. ‘3’).

FIG. 12 shows a chart 1200 that illustrates how a workload-centric preference in a resource profile may increase over time as a skill level increases. In the example of FIG. 12, a resource—technician A (“Tech A”) is shown. Prior to application of a set of learning rules, A's skill level for ‘test.R’ is 0 and B's skill level for ‘test.R’ is 4. As can be seen, B has a ‘high’ (e.g. ‘3’) workload-centric preference value over the 10 days; whereas A's workload-centric preference value increases as they are assigned to ‘test.R’ tasks and their skill level for ‘test.R’ increases (e.g. due to the skill acquisition learning rules described above). Consequently, the preference level for this scarce skill also increases as specified by the corresponding learning rule.

To demonstrate how updating variables in a resource profile influences assignments, an example of an assignment procedure will now be described with reference to FIG. 13. FIG. 13 shows a method 1300 of selecting suitable resources to be assigned to a task. The method of FIG. 13 may be implemented by, amongst others, any of systems 100, 200, 300 or 400, but for ease of explanation the features of FIG. 3 may be referenced. The method 1300 of FIG. 13 may be initiated when a scheduler 310 receives an instruction to schedule one or more tasks. This instruction may be received via a request handler 360 following a posting of a request to schedule a group of tasks performed by event-driven controller 370, e.g. following receipt of a client request via data I/O 380.

At block 1310 an unprocessed task is selected for assignment. If a group of tasks are to be assigned, this may be a first task or a highest rated or ranked task from a group (e.g. if a task priority is used). Details of the task may be retrieved by a request handler 360 from event-driven controller 370 and passed to scheduler 310. Block 1310 may involve retrieving a task profile associated with the selected task from schedule representation 390, or at least data associated with a task profile (e.g. a response to an API call). At block 1320 a set of candidate resources are determined based on a match between task characteristics derived from the task profile and resource characteristics set out in a resource profile. Block 1320 may involve retrieving a plurality of resource profiles from schedule representation 390, or at least data associated with a resource profile (e.g. a response to an API call). A match may be made using one or more heuristic rules. Matches may be ‘fuzzy’, i.e. based on a weighting, probability or score (hereafter a ‘weight’), wherein resources with a weight above a predetermined threshold are selected as candidate resources. At block 1330, candidate resources are ranked. This ranking may be applied based on the aforementioned weights and/or a candidate weighting scheme. For example, one or more weights may be applied based on a user-defined scale. If a plurality of heuristic rules is used, a weight may be applied based on each applied heuristic rule, wherein each weight may be configurable by a user. A match may comprise applying one or more heuristic rules to determine the suitability of a resource to a task and applying one or more heuristic rules to determine the suitability of a task for a resource. Weights for each heuristic rule may be combined, e.g. totalled or averaged, to produce a candidate weight. Candidate resources may then be ranked in descending order according to these candidate weights. At block 1340 each candidate resource is analyzed in more detail in rank order. For example, a candidate resource may have a tour of tasks for a day and the task may be inserted at different positions in the tour, e.g. at different times (and/or locations if the task is moveable). Each analysis may generate a cost of assignment for a candidate resource. As shown by the dotted line in FIG. 13, block 1340 may be iterated a number of times until all candidate resources have been analysed. Any suitable optimization or search routine may be used to implement block 1340. At block 1350, if one or more candidate resources exist, a particular candidate resource with a minimum (or maximum—depending on the metric used) cost is selected as a ‘best’ assignment. If no candidate resources exist a task may be left unassigned. Block 1350 thus outputs an assignment of a resource to a task. After one particular task has been assigned the method 1300 may be repeated to assign further tasks, e.g. starting with a second task in a group or the next-ranked task. Method 1300 may be repeated until all tasks have been processed. If no suitable assignment can be made for a task, e.g. there are no candidate resources or all candidate weights are below a suitability threshold, a task may be rejected for assignment and join a list of unassigned tasks. These may be assigned at a later point, e.g. at another time, if an existing tour or schedule changes due to unforeseen circumstances, or manually by a user.

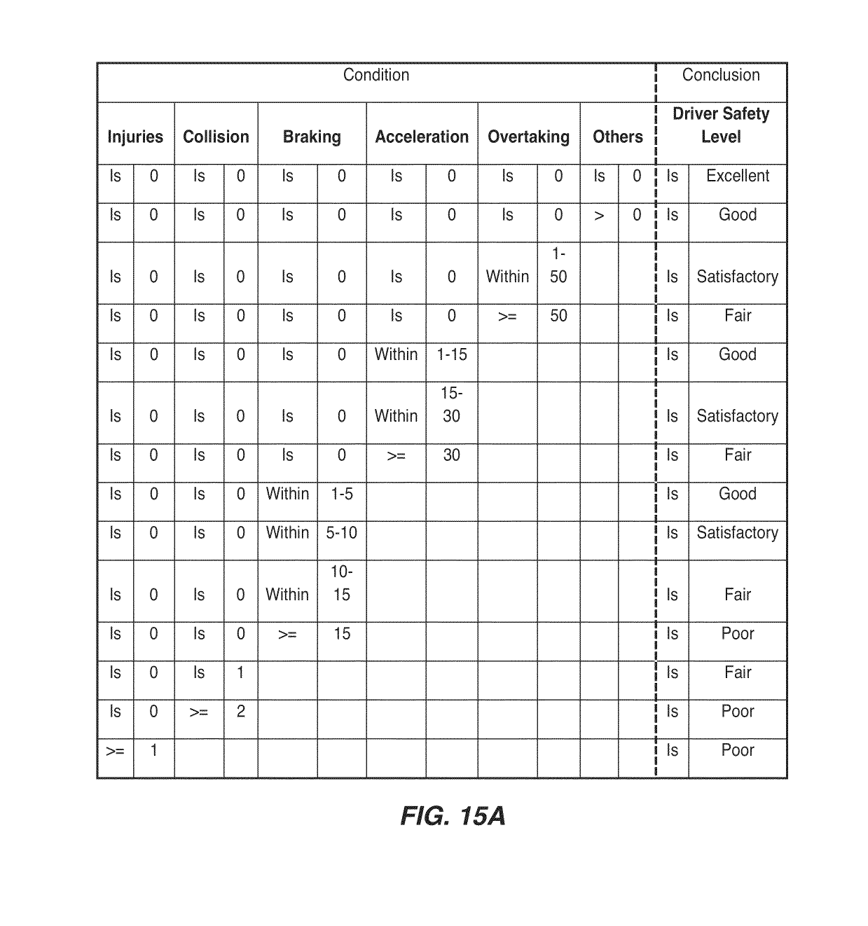

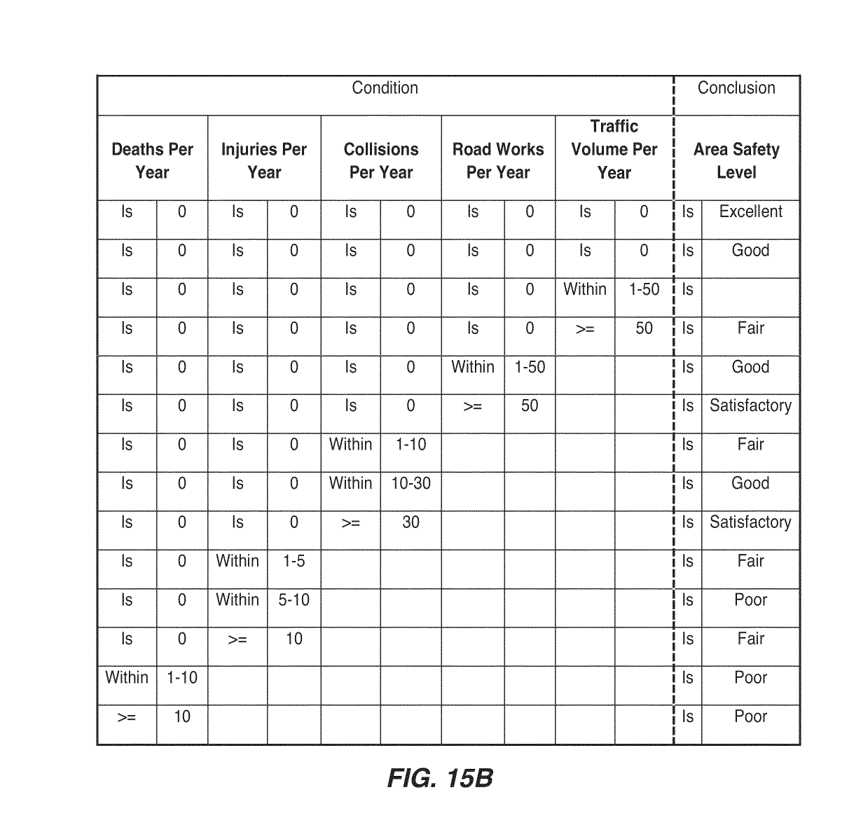

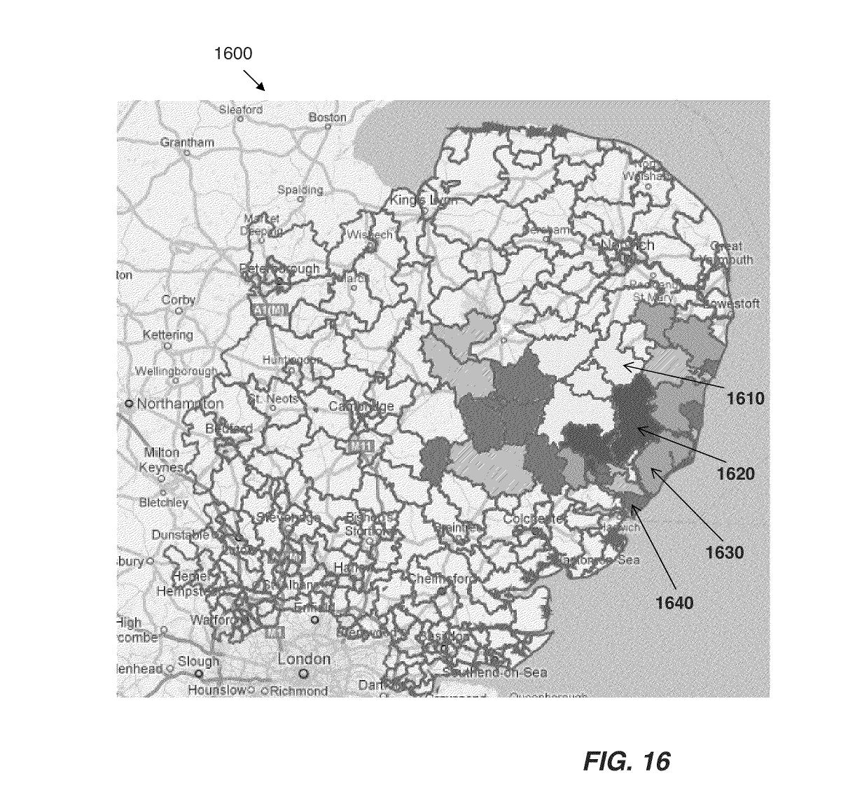

A specific example of a heuristic rule that may be used in the method 1300 of FIG. 13 is set out in FIG. 14. The heuristic rule is based on a transport safety level that may be set by a set of corresponding learning rules. The application of one or more learning rules for setting a transport safety level will first be described in relation to FIGS. 15A, 15B and 16.

In one implementation, a transport safety level is defined based on a driver safety variable that may form part of a resource profile for a human resource such as a driver and a geographical safety variable that may form part of, or be indicated in, a task profile. For example, in the latter case a task may have a location which may be used to look up a geographical safety variable that forms part of system data for a schedule representation.

FIG. 15A shows a number of conditions that may be applied to set a particular driver safety variable in a resource profile for the driver. As part of historic data for a driver the number of injuries, collisions, extreme braking manoeuvres, extreme acceleration manoeuvres, overtaking manoeuvres and other manoeuvres are recorded. For example, these variables may be recorded by a so-called black-box coupled to an engine control unit (ECU) of a motor vehicle, may be measured from incident reports or the like, and/or may be derived from navigation system (e.g. GPS) and/or mobile telecommunications devices such as so-called smartphones. Historic data for a driver may form part of assignment data, e.g. directly or through one or more linked records, or may be derived from one or more data sources coupled to a second engine. Each row of the table of FIG. 15A represents a different set of logical conditions that need to be met, based on the variable values, for a driver safety level to be set to a particular value. For example, the sixth row specifies that a driver safety level is set to ‘Satisfactory’ if an ‘injuries’ variable is 0, if a ‘collision’ variable is 0, if a ‘braking’ variable is 0, and if an ‘acceleration’ variable is within a range of 15 to 30. In one implementation, each row is applied to the historic data in turn. If the conditions in a row are met then the driver safety level is set as shown and processing stops; if any conditions are not met then a subsequent row is applied.

FIG. 15B shows a number of conditions that may be applied to set a particular geographical area safety variable. The conditions may be applied to data retrieved from a public data source, e.g. a public traffic management body, or recorded by an organisation. A geographical area may be a state or county, a post or zip code, or a user-defined area. FIG. 16 shows a screenshot of a map 1600 of the east of the United Kingdom with a number of marked geographical areas. For this example, simulated test data has been applied such that: area 1610 has a ‘fair’ geographical area safety variable value; area 1620 has a ‘poor’ geographical area safety variable value; area 1630 has a ‘Satisfactory’ geographical area safety variable value; and area 1640 has an ‘excellent’ geographical area safety variable value. The simulated test data has been provided to aid description of the present examples and any resemblance to actual values for the east of the United Kingdom is coincidental. Typically, safety variables are dynamic; as such FIG. 16 represents a snapshot of simulated test data at one point in time.

In one implementation, safety events may be recorded by an organisation for both resources and areas. A safety event may comprise a resource identifier, e.g. for a driver, a location, e.g. a geographical co-ordinate, and a timestamp, e.g. a time/date when the event occurred. A safety event may have a type: for a resource this may comprise dangerous overtaking, harsh braking, collision, acceleration, cornering etc.; for a geographical area this may comprise road works, traffic volume, injuries, deaths etc. A resource may have a safety history comprising all safety events that feature their resource identifier over a specified time period. A geographical area may have a safety history comprising all safety events with locations within the geographical area over a specified time period. A driver may be a technician or another member of staff. The variables used to evaluate the conditions shown in FIGS. 15A and 15B may be respectfully derived from a resource safety history and a geographical area safety history.

Returning to FIG. 14, a method 1400 of assigning a driver to one or more tasks is shown. In this example, a driver is assigned for a particular tour of tasks, e.g. they may be assigned to drive a vehicle to transport a technician to a task. In other examples, a driver may be assigned to a single task, using for example the method of FIG. 1300, and the task may comprise the delivery of an item or person. In FIG. 14, at block 1410 a safety level for a particular tour of tasks is determined. This may comprise: extracting a location for each task in the tour; determining a geographical area for each location, i.e. a geographical area that encompasses the location; determining a safety level variable value for each determined geographical area; and selecting a minimum (i.e. lowest) determined safety level variable value as the tour safety level. This effectively sets the tour safety level as the lowest safety level over all the geographical areas visited during a tour. In other implementations, a different tour safety level may be used, e.g. an average safety level may be calculated. At block 1420 a required resource safety level is determined. This is a resource safety level that is required to complement a geographical safety level. It may be defined by a mapping. In one example, a geographical safety level needs to be matched with an opposing resource safety level, e.g. ‘poor’ requires at least an ‘excellent’ level, ‘fair’ requires at least a ‘good’ level, ‘satisfactory’ requires at least a ‘satisfactory’ level, ‘good’ requires at least a ‘fair’ level and an ‘excellent’ geographical safety level can be matched with any driver (e.g. ‘poor’ and above).

At block 1430 a resource is selected. This may be a pre-selected candidate resource, e.g. as selected by block 1320, or block 1430 may form part of block 1320, e.g. be used to determine a candidate resource in which case the resource may be a first resource in a group of potential resources. At block 1440 a relative difference between a safety level variable value for the resource, e.g. as set out in a resource profile, and the required resource safety level value determined at block 1420 is determined. For example, if the required resource safety level value is ‘satisfactory’ and a resource has a safety level value of ‘good’, a relative difference may be 1 (e.g. if the safety level values correspond to a range from 1 to 5). At block 1450, the resource is ranked based on the relative difference determined at block 1440. In one case, resources with a negative relative difference, e.g. representing a resource safety level value below that required, may be discarded as candidate resources; in other cases a negative difference may lead to a negative weighting for block 1330 of FIG. 13. If there are a plurality of resources to rank then blocks 1430 to 1450 may be repeated, e.g. for a set of candidate resources determined in block 1320 of FIG. 13. In certain cases, blocks 1410 and 1420 may be performed following the selection of an unprocessed task in block 1310 of FIG. 13. Blocks 1430 to 1450 of FIG. 14 may then be applied at any of blocks 1320, 1330 or 1340 of FIG. 13.

The example method 1400 of FIG. 14 demonstrates how a safety level variable may be used to select appropriate resources for a task or tour of tasks. In FIG. 14, learned information (e.g. driver safety levels) is used during heuristic scheduling, with an objective of increasing schedule quality (in this case, schedule driver safety) during schedule construction and/or optimization. The method matches a safer resource in preference to a resource whose driving style is not safe and the degree of preference increases for geographical areas with recorded safety risks. Learning from past safety experience in this manner can reduce road accidents, associated insurance costs, fuel consumption, environmental impact and/or other negative implications of poor driver safety.

An example of data 1700 used to optimize an assignment of a resource to a task will now be described with reference to FIG. 17. FIG. 17 shows a portion of assignment data 1710 according to an example. In the example, assignment data 1710 is a record detailing an assignment of a resource with a resource identifier (<Resource>) of ‘John_Smith’ to a task with a task identifier (<Task>) of ‘Repair_Router_{—}#654321’. In this example, the assignment data 1710 has a name (<Assignment>—#123456) that may comprise a unique identifier either individually or in combination with a timestamp. In the present example, assignment data 1710 is a data file structured according to the conventions of a mark-up language, however alternative implementations include, amongst others, a record in a database, any other type of file, an entry in a file, the contents of a number of memory locations or a specialised set of memory registers. The assignment data 1710 of FIG. 17 also comprises: a field (<UserConfirm>) for storing whether the assignment has been confirmed by a user; a time/date field (<Completed>) specifying when the assignment was completed; a state field (<Active>) denoting that, in this case, an active state, for example as described with reference to FIG. 6B above, is ‘true’ (an inactive state would have a ‘false’ value); and a timestamp (<T>) setting out a time when the assignment was made (e.g. by a first engine). The timestamp may alternatively be set to a time when the assignment was processed by a second engine and/or added to a set of historic assignments.

The assignment data 1710 is linked to a resource profile 1730 via the resource identifier (i.e. ‘John_Smith’) and linked to a task profile 1740 via a task identifier (i.e. Repair_Router_{—}#654321). In the example of FIG. 17 the task identifier identifies a file comprising the task profile but in other implementations it may correspond, for example, to a primary key of a record in a database. In the example of FIG. 17 both the resource profile 1730 and the task profile 1740 have a tabular data structure. Resource profile 1730 sets out the following fields: ‘ID’—the resource identifier; ‘Home_Location’—a home location for the resource; ‘I.Skill_Level’—a skill level value for installations; ‘R.R.Skill_Level’—a skill level value for repairing routers; ‘M.H.Ma1.Skill_Level’—a skill level value for maintaining hubs from a first manufacturer; ‘T.R.MaN.Mo1.Skill_Level’—a skill level value for testing ‘model 1’ routers from an Nth manufacturer; ‘I.Preference’—a preference level value for installations; ‘M.Preference’—a preference level value for maintenance work; ‘T.Preference’—a preference level value for testing; ‘Scarce.Preference’—a preference level value for scarce work; and ‘D.Safety_Level’—a driver safety level value. These fields are shown for example only and other fields, e.g. other skill level values, may be found in actual implementations. As described in the examples above these fields of a resource profile are updated by a second engine based on tasks assigned over time.

In a similar manner task profile 1740 sets out the following fields: ‘ID’—a task identifier; ‘Location’—a location at which a task is to be performed, here defined by a geographical co-ordinate; ‘Equipment’—details of equipment associated with the task, here a ‘model 2’ router produced by a first manufacturer; and ‘Task_Type’ a type of task to be performed, here a repair (‘R’) task (i.e. the ‘model 2’ router needs repairing). In FIG. 17 a log file 1750 (‘R.Ma1.Mo2_Log’) for the equipment referred to in the task profile 1740 is also shown. In certain examples a task may be generated based on a processing of an equipment log file. For example, log file 1750 shows that an update scheduled for 01:05 has produced an error that in turn leads to a communication error at 01:30 and a failed reboot at 02:00. In certain examples, there may be an automated system that monitors and processes log files, such as 1750, and then automatically requests a repair task, such as is shown in task profile 1740. A request for a repair task may be received together with the task profile by a controller such as event-driven controller 270 or 370.

FIG. 17 also demonstrates how an assignment may form part of a tour of tasks. FIG. 17 shows a tour record 1720 that references a plurality of assignments to be performed at particular times. For example, in FIG. 17 the assignment defined by assignment data 1710 (i.e. assignment ‘#123456’) is scheduled to be performed at 11:00, i.e. at 11:00 resource ‘John_Smith’ is scheduled to perform task ‘Repair_Router_{—}#654321’. Two further assignments are also scheduled for 13:00 and 14:00. The tour record 1720 may be produced for resource ‘John_Smith’. FIG. 17 also shows a GPS log file (‘GPS_Log’) 1760 for resource ‘John_Smith’. The GPS log file 1760 sets out a plurality of location recordings at particular times, as may be performed by a GPS device. In FIG. 17, the GPS log file 1760 may be used to confirm that resource ‘John_Smith’ performed a scheduled task by checking the location recorded in the GPS log file 1760 at a scheduled time with a task profile location. In FIG. 17, at 11:00 resource ‘John_Smith’ was located at co-ordinate ‘N345E229’ which is within a predetermined range of the location in the task profile ‘N345E230’, wherein the task was scheduled to be performed at 11:00. Hence, geographic areas visited by mobile workforce may be confirmed by a GPS device. A user confirmation field (<UserConfirm>) in the assignment data 1710 may also be used in a similar manner. For example, an assignment may only be used in a learning system if an assignment status is confirmed. For example, a user may close an assignment at the end of a tour by confirming whether a task was completed successfully, is on-hold (e.g. has been postponed) or was not completed (e.g. has failed). In some examples, a task closure status may be set automatically, e.g. based on confirmed location data, automated customer feedback or equipment monitoring systems. Only assignments featuring tasks that were completed successfully may be used by a second engine. However, the particular example condition that learning is based on successfully completed tasks is only one of several configuration options for the learning process.

As described herein, learning may be based on a set of pluggable rules, which may further be defined by a user. As such learning, as described in certain examples herein, is flexible and extensible. In certain embodiments, a second engine is arranged to retrieve historic assignment data and real-time assignment data generated by a first engine to iteratively update resource profile data in accordance with a set of rules.

In one variation, the method of FIG. 6A may be adapted to update resource attributes other than a preferred working area. For example, task location data may be used to set mobile resource attributes that represent a mobile resource's familiarity with particular point locations, installations and/or geographically-specific parties. Additionally a resource attribute may be updated to indicate security and/or access considerations for a particular point location or area.

Learned knowledge can both be used by scheduler/optimizer components and be made available to a user in the form of advice about the implications of their choices. The learning methodology described herein may be arranged to integrate data from a plurality of data sources, feeds or streams, wherein the data represents information recorded at various stages in an enterprise resource planning process-cycle. For example, the data may relate to resource skills, safety historic trends, learning stability, geographic aspects of workforce expertise, workload patterns, asset diagnostics, customer feedback, etc. By automating the learning methodology as described herein advantages may be gained over manual systems, for example there may be improvements in uncertain dynamic environments where it is not possible for a human operator to integrate a large number of data sources in real-time. They also provide for more stable assignments. For example, the learning methodology described in certain examples herein provides advantages in systems with a mobile workforce, systems where differences can arise between planned and executed task schedules, systems where there may be uncertainty in schedule execution times (e.g. those dependent on driving conditions, customer availability, asset stock levels, job durations, etc.).

The application of the described skill rules may not prevent a user from manually assigning any resource to any task irrespective of the level of resource expertise and notwithstanding an automated assignment. For example, a user may overrule an automatic allocation or decline a recommended assignment.

Certain described examples present systems and methods for incorporating acquired knowledge accuracy degradation over time (e.g. knowledge ageing). Knowledge, as represented in resource profiles, that is subject to ageing enables on-going adaptation to the ever changing characteristics of the scheduling/resource allocation problem. For example, as described herein assignments may become expired and consequently preferred working areas may change. Likewise, skills can degrade over time. Certain systems described herein can deal with this efficiently and effectively. A learning component, such as the described second engine, can be configured to be “oblivious” to particular items of data to varying degrees, which is useful in configuring the system. Similarly, certain learning systems described herein can operate in perpetuity and are capable of boot-strapped initialization, i.e. can accommodate the absence of particular data.

The use of the knowledge representations described herein may be two-fold. In a first use, an assignment cost is updated based on matching of task and resource characteristics, for example favoring an assignment with resources that have appropriate skills and are familiar with a task's geographic area. In a second use, assignment heuristic rules that are used in automatic schedule construction and/or modification may use the knowledge representations to preferably select assignments with desired properties.

Updated resource profile characteristics, as described in certain examples herein, may be used to advise a user during an initiated dialog, e.g. to suggest suitable assignments or the outcome of assignments. Certain systems described deal with exceptions during a scheduling process and provide useful guidance and insight into possible reasons why these exceptions occurred.

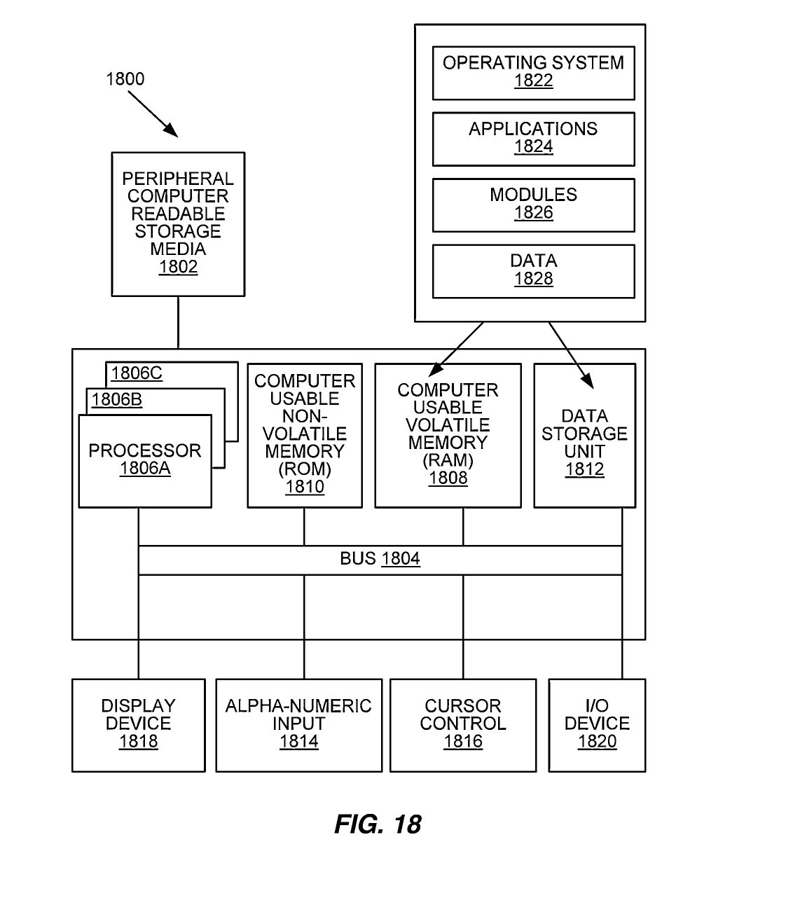

With reference now to FIG. 18, all or portions of some embodiments described herein are composed of computer-readable and computer-executable instructions that reside, for example, in computer-usable/computer-readable storage media of a computer system. That is, FIG. 18 illustrates one example of a type of computer (computer system 1800) that can be used in accordance with or to implement various embodiments which are discussed herein. It is appreciated that computer system 1800 of FIG. 18 is only an example and that embodiments as described herein can operate on or within a number of different computer systems including, but not limited to, general purpose networked computer systems, embedded computer systems, processing engines/components, server devices, client devices, various intermediate devices/nodes, stand alone computer systems, media centers, handheld computer systems, multi-media devices, and the like. Computer system 1800 of FIG. 18 is well adapted to having peripheral tangible computer-readable storage media 1802 such as, for example, a floppy disk, a compact disc, digital versatile disc, other disc based storage, universal serial bus “thumb” drive, removable memory card, and the like coupled thereto. The tangible computer-readable storage media is non-transitory in nature.

System 1800 of FIG. 18 includes an address/data bus 1804 for communicating information, and a processor 1806A coupled with bus 1804 for processing information and instructions. As depicted in FIG. 18, system 1800 is also well suited to a multi-processor environment in which a plurality of processors 1806A, 1806B, and 1806C are present. Conversely, system 1800 is also well suited to having a single processor such as, for example, processor 1806A. Processors 1806A, 1806B, and 1806C may be any of various types of microprocessors. System 1800 also includes data storage features such as a computer usable volatile memory 1808, e.g., random access memory (RAM), coupled with bus 1804 for storing information and instructions for processors 1806A, 1806B, and 1806C. System 1800 also includes computer usable non-volatile memory 1810, e.g., read only memory (ROM), coupled with bus 1804 for storing static information and instructions for processors 1806A, 1806B, and 1806C. Also present in system 1800 is a data storage unit 1812 (e.g., a magnetic or optical disk and disk drive) coupled with bus 1804 for storing information and instructions. System 1800 also includes an optional alphanumeric input device 1814 including alphanumeric and function keys coupled with bus 1804 for communicating information and command selections to processor 1806A or processors 1806A, 1806B, and 1806C. System 1800 also includes an optional cursor control device 1816 coupled with bus 1804 for communicating user input information and command selections to processor 1806A or processors 1806A, 1806B, and 1806C. In one embodiment, system 1800 also includes an optional display device 1818 coupled with bus 1804 for displaying information.

Referring still to FIG. 18, optional display device 1818 of FIG. 18 may be a liquid crystal device, cathode ray tube, plasma display device or other display device suitable for creating graphic images and alphanumeric characters recognizable to a user. Optional cursor control device 1816 allows the computer user to dynamically signal the movement of a visible symbol (cursor) on a display screen of display device 1818 and indicate user selections of selectable items displayed on display device 1818. Many implementations of cursor control device 1816 are known in the art including a trackball, mouse, touch pad, joystick or special keys on alphanumeric input device 1814 capable of signaling movement of a given direction or manner of displacement. Alternatively, it will be appreciated that a cursor can be directed and/or activated via input from alphanumeric input device 1814 using special keys and key sequence commands. System 1800 is also well suited to having a cursor directed by other means such as, for example, voice commands. System 1800 also includes an I/O device 1820 for coupling system 1800 with external entities. For example, in one embodiment, I/O device 1820 is a modem for enabling wired or wireless communications between system 1800 and an external network such as, but not limited to, the Internet.

Referring still to FIG. 18, various other components are depicted for system 1800. Specifically, when present, an operating system 1822, applications 1824, modules 1826, and data 1828 are shown as typically residing in one or some combination of computer usable volatile memory 1808 (e.g., RAM), computer usable non-volatile memory 1810 (e.g., ROM), and data storage unit 1812. In some embodiments, all or portions of various embodiments described herein are stored, for example, as an application 1824 and/or module 1826 in memory locations within RAM 1808, computer-readable storage media within data storage unit 1812, peripheral computer-readable storage media 1802, and/or other tangible computer-readable storage media.

Although at least some aspects of the examples described herein with reference to the drawings comprise computer processes performed in processing systems or processors, embodiments described herein also extend to computer programs, particularly computer programs on or in a carrier, adapted for putting the examples into practice. The program may be in the form of non-transitory source code, object code, a code intermediate source and object code such as in partially compiled form, or in any other non-transitory form suitable for use in the implementation of processes according to the embodiments described herein. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The above embodiments are to be understood as illustrative, but non-limiting examples. Further examples are envisaged. For example, a number of learning rules have been described to demonstrate one or more concepts underlying the examples, in a practical implementation greater complexity in rule structure is possible.

It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the described embodiments, which is defined in the accompanying claims.

What is claimed is:

1. A system comprising:
a first engine configured to determine an assignment of a resource to a task, the assignment being based on a schedule representation comprising at least resource profile data and task profile data, the resource profile data representing a resource profile associated with the resource and the task profile data representing a task profile associated with the task;
a data store configured to store a set of rules, the set of rules comprising data indicative of one or more functions to be applied to one or more input data sources to output at least one variable value for the schedule representation; and
a second engine coupled to the data store and configured to update the schedule representation in accordance with the set of rules.

2. The system according to claim 1, wherein the second engine is arranged to monitor a plurality of assignments determined by a first engine and to store said plurality of assignments as historic assignment data in an assignment data store.

3. The system according to claim 2, wherein the task profile data comprises task location data indicating a geographical location where the task is to be performed and the second engine is configured to process historic assignment data from the assignment data store to update one or more variable values within the resource profile data using at least the task location data indicated by the historic assignment data as an input data source for the set of rules.

4. The system according to claim 3, wherein the one or more variable values comprise preferred working area data defining a preferred working area for a resource.

5. The system according to claim 3, wherein task location data associated with an assignment is confirmed using an electronic positioning device.

6. The system according to claim 2, wherein:
the task profile data indicates one or more associated task properties;
the historic assignment data comprises data indicative of one or more task properties for the task in an assignment;
the resource profile data comprises at least a first set of one or more variables defining experience for the resource;
the first set of one or more variables is associated with at least one task property; and
the second engine is configured to process one or more task properties indicated in the historic assignment data to update the first set of one or more variables.

7. The system according to claim 6, wherein the set of rules comprises a rule to instruct the second engine to update the first set of one or more variables for a first task property based on historic assignment data indicating one or more tasks having a second task property and data defining a relationship between the first task property and the second task property.

8. The system according to claim 7, wherein the set of rules comprises a rule to instruct the second engine to update the first set of one or more variables based on data defining a hierarchical skill level structure.

9. The system according to claim 8, wherein the resource profile data indicates one or more preferences of the resource, preference data associated with said one or more preferences being updated by the second engine based on at least the historic assignment data in accordance with one or more rules in the set of rules, the one or more rules determining preference data values as a function of the first set of one or more variables.

10. The system according to claim 1, wherein the second engine is configured to process each assignment determined by the first engine to set an assignment state in accordance with one or more rules retrieved from the data store, an assignment state being one of active or inactive, wherein assignments with an active state are used to update a preferred working area data for the resource.

11. The system according to claim 10, wherein the set of rules comprises a rule to instruct the second engine to set an assignment state based on geographic clustering.

12. The system according to claim 1, wherein an assignment determined by the first engine is used to perform at least one of the following operations selected from the list consisting of:
generate a schedule of tasks to be performed for a resource;
optimize one or more existing schedules of tasks; and
advise a user on a modification to one or more existing schedules of tasks.

13. The system according to claim 1, wherein the set of rules is configurable by a user through a configuration interface.

14. The system according to claim 1, wherein the first engine is arranged to:
select an unassigned task;
retrieve task profile data for the selected unassigned task; and
heuristically determine an assignment of a resource to the selected unassigned task based on a comparison of resource profile data for the resource with the task profile data for the selected unassigned task, the resource being selected from a plurality of candidate resources based on a score resulting from the comparison.

15. The system according to claim 1, wherein one of said one or more input data sources comprises a travel event history for a resource and the resource profile data indicates a travel safety profile for the resource, the travel safety profile being determined from the travel event history by the second engine in accordance with at least one rule in the set of rules.

16. The system according to claim 15, wherein the task profile data comprises task location data indicating a geographical location associated with a task, the task location data having an associated location safety profile for the location, the first engine being configured to heuristically determine an assignment of the resource to the task based on a match between the travel safety profile and the location safety profile.

17. The system according to claim 1, comprising:
a graphical user interface for presenting an assignment generated by the first engine to a user, the graphical user interface comprising one or more controls to enable the user to set a closure status for the assignment,
wherein a record of the closure status for a plurality of assignments comprise one of said one or more data sources.

18. A method of updating resource data, the method comprising:
accessing, with a computer system, a set of rules from a data store, the set of rules comprising data indicative of one or more functions to be applied to one or more input data sources to output at least one variable value for a schedule representation comprising at least resource profile data representing a resource profile associated with a resource and task profile data representing a task profile associated with the task;
processing, with the computer system, the one or more input data sources to update the schedule representation in accordance with the set of rules; and
determining, with the computer system, an assignment of the resource to a task, the assignment being based on the schedule representation.

19. The method according to claim 18, comprising:
processing, with the computer system, the assignment and storing, with the computer system, said assignment as historic assignment data in an assignment data store, the assignment data store comprising one of said one or more input data sources.

20. The method according to claim 19, wherein:
the task profile data comprises task location data indicating a geographic location where the task is to be performed; and processing the one or more input data sources comprises:
processing the historic assignment data to update one or more variable values within the resource profile data for a resource using at least the task location data indicated by the historic assignment data.

21. The method according to claim 20, wherein the one or more variable values comprise preferred working area data defining a preferred working area for a resource.

22. The method according to claim 20, comprising:
confirming task location data associated with an assignment using an electronic positioning device.

23. The method according to claim 22, wherein the set of rules comprises a rule to set an assignment state based on geographic clustering.

24. The method according to claim 19, wherein processing the assignment and storing said assignment as historic assignment data comprises:
assigning an assignment state, an assignment state being one of active or inactive,
wherein assignments with an active state are used to update a preferred working area data for the resource.

25. The method according to claim 19, wherein:
the task profile data indicates one or more associated task properties;
the historic assignment data comprises data indicative of one or more task properties for the task in an assignment;
the resource profile data comprises at least a first set of one or more variables defining an experience level for the resource;
the first set of one or more variables is associated with at least one task property; and
processing the assignment data comprises:
processing one or more task properties indicated in the historic assignment data to update the first set of one or more variables.

26. The method according to claim 25, wherein the set of rules comprises a rule to instruct the update of the first set of one or more variables for a first task property based on historic assignment data indicating one or more tasks having a second task property and a data defining a relationship between the first task property and the second task property.

27. The method according to claim 26, wherein the set of rules comprises a rule to instruct the update of the first set of one or more variables based on data defining a hierarchical skill level structure.

28. The method according to claim 26, wherein the resource profile data indicates one or more preferences of the resource and processing the assignment data comprises:
updating preference data associated with said one or more preferences based on at least the historic assignment data in accordance with one or more rules in the set of rules, the one or more rules determining preference data values as a function of the first set of one or more variables.

29. The method according to claim 18, further comprising:
generating a schedule of tasks to be performed for a resource based on the determined assignment of the resource to the task.

30. The method according to claim 18, further comprising:
optimizing one or more existing schedules of tasks based on the determined assignment of the resource to the task.

31. The method according to claim 18, further comprising:
advising a user of a modification to one or more existing schedules of tasks based on the determined assignment of the resource to the task.

32. The method according to claim 18, comprising:
configuring the set of rules using a configuration interface.

33. The method according to claim 18, wherein determining one or more assignments comprises:
selecting an unassigned task;
retrieving task profile data for the selected unassigned task; and
determining an assignment of a resource to the selected unassigned task based on a comparison of resource profile data for the resource with the task profile data for the selected unassigned task, the resource being selected from a plurality of candidate resources based on a score resulting from the comparison.

34. The method according to claim 18, wherein one of said one or more data sources comprises a travel event history for a resource, the resource profile data indicates a travel safety profile for the resource and processing the assignment data comprises:
determining the travel safety profile from the travel event history in accordance with at least one rule in the set of rules.

35. The method according to claim 34, wherein the task profile data comprises task location data indicating a geographical location associated with a task, the task location data having an associated location safety profile for the location, and determining one or more assignments comprises:
determining one or more assignments of the at least one resource to the task based on a match between the travel safety profile and the location safety profile.

36. A computer program product comprising a non-transitory computer-readable storage medium having computer-readable instructions stored thereon, the computer readable instructions being executable by a computerized device to cause the computerized device to perform a method of updating resource data, the method comprising:
accessing a set of rules from a data store, the set of rules comprising data indicative of one or more functions to be applied to one or more input data sources to output at least one variable value for a schedule representation comprising at least resource profile data representing a resource profile associated with a resource and task profile data representing a task profile associated with the task;
processing the one or more input data sources to update the schedule representation in accordance with the set of rules; and
determining an assignment of the resource to a task, the assignment being based on the schedule representation.
